(19) United States
(12) Patent Application Publication
(10) Pub. No.: US 2012/0249499 A1
(43) Pub. Date: Oct. 4, 2012

(54) DISPLAY PANEL AND INSPECTION METHOD THEREOF

(75) Inventors: Isao Takahashi, Osaka (JP); Shige Furuta, Osaka (JP); Yuhichiroh Murakami, Osaka (JP); Yasushi Sasaki, Osaka (JP)

(73) Assignee: SHARP KABUSHIKI KAISHA, Osaka-shi, Osaka (JP)

(21) Appl. No.: 13/513,017

(22) PCT Filed: Oct. 7, 2010
(86) PCT No.: PCT/JP2010/067649

§ 371 Date: May 31, 2012

(30) Foreign Application Priority Data
Jan. 19, 2010 (JP) 2010-009023

(51) Int. Cl. G06F 3/038

(52) U.S. Cl. 345/204

(57) ABSTRACT

A one-input and three-output demultiplexer that includes sampling switches for sampling a video signal is provided at one end side of source bus lines, and a one-input and three-output demultiplexer that includes test switches provided corresponding to sampling switches and that uses a test video signal as an input signal is provided at the other end side of the source bus lines. When an any control signal out of three control signals for controlling states of a sampling switch and a test switch is defined as a target control signal, a source bus line connected to the sampling switch which is set to an on state by the target control signal and a source bus line connected to the test switch which is set to an on state by the target control signal are different.

### TECHNICAL FIELD

The present invention relates to a display panel, and particularly relates to a display panel that includes a demultiplexer for distributing a video signal to a plurality of video signal lines, and to an inspection method of the display panel.

### BACKGROUND ART

Conventionally, a liquid crystal module is manufactured by mounting a driver IC (a driver integrated circuit) on a liquid crystal panel in a module manufacturing process, after an array manufacturing process, a panel manufacturing process, and the like. In general, before the driver IC is mounted, an inspection for checking the presence or absence of defects of the liquid crystal panel (hereinafter, referred to as a “panel inspection”) is performed. Therefore, a test circuit is often formed beforehand on a substrate that constitutes the liquid crystal panel. FIG. 31 is a block diagram showing a configuration of relevant parts of a liquid crystal module that has a driver IC mounted on a liquid crystal panel which includes such a test circuit. The liquid crystal module is configured by a pixel circuit unit 90 as a region in which source bus lines SL and gate bus lines (not shown) are disposed and an image is displayed; source drivers 94 as driver ICs that drive the source bus lines SL; a first distribution circuit 91 that outputs video signals transmitted from the source drivers 94 to the plurality of source bus lines SL while switching output destinations; a second distribution circuit 92 that outputs a test video signal transmitted from an outside to the plurality of source bus lines SL while switching output destinations; and a switching circuit 93 that is adapted to switch an output source of the video signals to the source bus lines SL between the first distribution circuit 91 and the second distribution circuit 92. These constituent elements are formed on one glass substrate (generally called an “array substrate”) out of two glass substrates that constitute the liquid crystal panel. In this configuration, the second distribution circuit 92 functions as a test circuit. Note that, at a time point of performing the panel inspection, the source drivers 94 are not yet mounted on the glass substrate.

FIG. 32 is a circuit diagram showing a configuration of the first distribution circuit 91, the second distribution circuit 92, and the switching circuit 93. FIG. 32 shows only six source bus lines SL1 to SL6 out of a plurality of source bus lines. In the first distribution circuit 91, a one-input and three-output demultiplexer is provided for every three source bus lines for red, green, and blue. Because each demultiplexer has one input and three outputs, each demultiplexer includes three switches (thin-film transistors, for example). Similarly, in the second distribution circuit 92, a one-input and three-output demultiplexer is also provided for every three source bus lines for red, green, and blue, and each demultiplexer includes three switches (thin-film transistors, for example). The first distribution circuit 91 is configured such that different video signals are provided to the plurality of demultiplexers. Note that, at a time point of performing a panel inspection, a video signal is not provided from an outside to the first distribution circuit 91, because the source drivers 94 are not yet mounted. On the other hand, the second distribution circuit 92 is configured such that a common (one) test video signal T_VIDEO is provided to the plurality of demultiplexers as an input signal. In the following description, a switch that constitutes a demultiplexer in the first distribution circuit 91 is called a “sampling switch”, and a switch that constitutes a demultiplexer in the second distribution circuit 92 is called a “test switch”.

The switching circuit 93 includes a first switch group 931 that includes three switches, a second switch group 932 that includes three switches, and an inverter 933. On/off states of switches included in the first switch group 931 are controlled by a control signal T_SMP provided from an outside, and on/off states of switches included in the second switch group 932 are controlled by a logical inverse signal of the control signal T_SMP. In this configuration, a logic level of the control signal T_SMP during a period when a panel inspection is performed (hereinafter, referred to as a “inspection-period”) and a logic level of the control signal T_SMP during a period when a normal operation is performed in a state of the liquid crystal module (hereinafter, referred to as a “normal-period”) are switched from each other. Accordingly, on/off states of switches included in the first switch group 931 and switches included in the second switch group 932 are switched between the inspection-period and the normal-period. In the following description, the control signal T_SMP is also called a “switching control signal”.

Control signals ASW1 to ASW3 are provided from an outside to the circuit shown in FIG. 32. When switches included in the first switch group 931 are in an on state, the control signal

ASW1 is provided to the second distribution circuit 92 as a control signal T_ASW1, the control signal ASW2 is provided to the second distribution circuit 92 as a control signal T_ASW2, and the control signal ASW3 is provided to the second distribution circuit 92 as a control signal T_ASW3. When switches included in the second switch group 932 are in an on state, the control signal ASW1 is provided to the first distribution circuit 91 as a control signal U_ASW1, the control signal ASW2 is provided to the first distribution circuit 91 as a control signal U_ASW2, and the control signal ASW3 is provided to the first distribution circuit 91 as a control signal U_ASW3. In the following description, each of the control signals ASW1 to ASW3 is also called a “distribution control signal”, each of the control signals U_ASW1 to U_ASW3 is also called a “normal-use distribution control signal”, and each of the control signals T_ASW1 to T_ASW3 is also called an “inspection-use distribution control signal”.

In the configuration described above, at an inspection-period, based on the switching control signal T_SMP, switches included in the first switch group 931 are set to an on state, and switches included in the second switch group 932 are set to an off state. As a result, corresponding to a logic level of each of the distribution control signals ASW1 to ASW3, each test switch in the second distribution circuit 92 becomes in either an on state or an off state. An inspection of the liquid crystal panel is performed, by changing a potential of the test video signals T_VIDEO while changing on/off states of test switches in the second distribution circuit 92 in this way.

On the other hand, at a normal-period, based on the switching control signal T_SMP, switches included in the first switch group 931 are set to an off state, and switches included in the second switch group 932 are set to an on state. As a result, corresponding to a logic level of each of the distribution control signals ASW1 to ASW3, each sampling switch in the first distribution circuit 91 becomes in either an on state or an off state. A desired image display is performed on the liquid crystal panel, by providing video signals from the source drivers 94 to the first distribution circuit 91 while changing on/off states of sampling switches in the first distribution circuit 91 in this way.

Considering that a video signal is not provided to the first distribution circuit 91 when a panel inspection is performed, a relationship of distribution control signals that are set to a high level with source bus lines to which data is written in a normal-period and source bus lines to which data is written in an inspection-period is as shown in FIG. 33.

In association with the present invention, the following prior-art document is known. Japanese Patent Application Laid-open Publication No. 2007-206440 discloses an invention regarding a substrate for an electro-optic device having a configuration in which demultiplexers for distributing data signals are provided at one end side of data lines and a test circuit including a shift register is provided at the other end side of the data lines.

### PRIOR ART DOCUMENT

### Patent Document

[Patent Document 1] Japanese Patent Application Laid-open Publication No. 2007-206440

### SUMMARY OF THE INVENTION

### Problems to be Solved by the Invention

However, according to the configuration disclosed in Japanese Patent Application Laid-open Publication No. 2007-206440, a circuit area is relatively large, because the test circuit includes a shift register. Therefore, it is difficult to reduce a size of a picture frame of the panel. Further, because the test control circuit operates based on a voltage of a read line, a device that measures the voltage of the read line is necessary.

Further, according to the configuration shown in FIG. 32, switches included in the second switch group 932 are maintained in an off state during a period when a panel inspection is being performed. Therefore, sampling switches in the first distribution circuit 91 are maintained in an off state during a period when a panel inspection is being performed. Consequently, when performing a panel inspection, a failure of a sampling switch cannot be detected.

Therefore, an object of the present invention is to realize a display panel that can also detect, when performing a panel inspection, a failure of a sampling switch which operates in a normal-period, without increasing a circuit scale.

### Means for Solving the Problems

A first aspect of the present invention is directed to a display panel comprising:
a display unit in which a plurality of video signal lines are disposed that constitute a set of grouped video signal lines for every n (n is a natural number equal to or larger than two) video signal lines;
a first demultiplexer provided for each of the set of grouped video signal lines at one end side of the plurality of video signal lines and including n first switches adapted to switch whether to apply a first video signal transmitted from an outside to each of the n video signal lines included in the grouped video signal lines;
a second demultiplexer provided for each of the set of grouped video signal lines at the other end side of the plurality of video signal lines and including n second switches adapted to switch whether to apply a second video signal transmitted from an outside to each of the n video signal lines included in the grouped video signal lines; and
an operation control unit adapted to switch whether to allow the second video signal to be applied to the plurality of video signal lines, wherein
states of the n first switches included in the first demultiplexer are controlled by n control signals which are different from each other,
states of the n second switches included in the second demultiplexer are controlled by the n control signals which are different from each other, and
when an any control signal out of the n control signals is defined as a target control signal, for each grouped video signal line, a video signal line connected to a first switch which is set to an on state by the target control signal and a video signal line connected to a second switch which is set to an on state by the target control signal are different.

According to a second aspect of the present invention, in the first aspect of the present invention,
the operation control unit includes n control switches provided respectively corresponding to the n second switches included in the second demultiplexer, and
each of the control switches controls whether to provide the control signal to the second switch, based on a switching control signal provided from an outside.

According to a third aspect of the present invention, in the first aspect of the present invention,
the operation control unit includes a plurality of control switches which are provided respectively corresponding to the plurality of video signal lines and are provided between an output unit of the second demultiplexer and the display unit, and
each of the control switches switches whether to allow the second video signal to be applied from the output unit of the second demultiplexer to the plurality of video signal lines, based on a switching control signal provided from an outside.

According to a fourth aspect of the present invention, in the first aspect of the present invention,
the operation control unit includes a plurality of control switches which are provided respectively corresponding to the plurality of video signal lines and are provided near an input unit of the second demultiplexer, and
each of the control switches switches whether to apply the second video signal to the input unit of the second demultiplexer, based on a switching control signal provided from an outside.

According to a fifth aspect of the present invention, in the first aspect of the present invention,
the second video signal is provided in common to input units of all second demultiplexers provided at the other end side of the plurality of video signal lines.

According to a sixth aspect of the present invention, in the first aspect of the present invention,
the n first switches included in the first demultiplexer and the n second switches included in the second demultiplexer are thin-film transistors.

A seventh aspect of the present invention is directed to a display module comprising the display panel according to the first aspect of the present invention, wherein
a video signal line drive circuit that applies the first video signal to the first demultiplexer is mounted on the display panel.

An eighth aspect of the present invention is directed to an inspection method of a display panel that includes a display unit in which a plurality of video signal lines are disposed that constitute a set of grouped video signal lines for every n (n is a natural number equal to or larger than two) video signal lines, a first demultiplexer provided for each of the set of grouped video signal lines at one end side of the plurality of video signal lines and including n first switches adapted to switch whether to apply a first video signal transmitted from an outside to each of the n video signal lines included in the grouped video signal lines, a second demultiplexer provided for each of the set of grouped video signal lines at the other end side of the plurality of video signal lines and including n second switches adapted to switch whether to apply a second video signal transmitted from an outside to each of the n video signal lines included in the grouped video signal lines, an operation control unit adapted to switch whether to allow the second video signal to be applied to the plurality of video signal lines, and a control signal input unit for receiving n control signals transmitted from an outside, the inspection method comprising:
an inspection preparation step of enabling the operation control unit to apply the second video signal to the plurality of video signal lines;
a first level application step of changing a signal level of one of the n control signals such that one of the n first switches included in the first demultiplexer provided corresponding to each grouped video signal line and one of the n second switches included in the second demultiplexer provided corresponding to each grouped video signal line are maintained in an on state in a predetermined period, when a signal level of the second video signal is at a predetermined first level; and
a second level application step of changing a signal level of one of the n control signals such that one of the n first switches included in the first demultiplexer provided corresponding to each grouped video signal line and one of the n second switches included in the second demultiplexer provided corresponding to each grouped video signal line are maintained in an on state in a predetermined period, when a signal level of the second video signal is at a second level which is different from the first level, wherein
when an any control signal out of the n control signals is defined as a target control signal, for each grouped video signal line, a video signal line connected to a first switch which is set to an on state by the target control signal and a video signal line connected to a second switch which is set to an on state by the target control signal are different,
the first level application step is performed such that the second video signal of the first level is applied to a video signal line which corresponds to a display color to be tested, and
the second level application step is performed such that the second video signal of the second level is applied to a video signal line which corresponds to a display color not to be tested.

A ninth aspect of the present invention is directed to an inspection method of a display panel that includes a display unit in which a plurality of video signal lines are disposed that constitute a set of grouped video signal lines for every n (n is a natural number equal to or larger than two) video signal lines, a first demultiplexer provided for each of the set of grouped video signal lines at one end side of the plurality of video signal lines and including n first switches adapted to switch whether to apply a first video signal transmitted from an outside to each of the n video signal lines included in the grouped video signal lines, a second demultiplexer provided for each of the set of grouped video signal lines at the other end side of the plurality of video signal lines and including n second switches adapted to switch whether to apply a second video signal transmitted from an outside to each of the n video signal lines included in the grouped video signal lines, an operation control unit adapted to switch whether to allow the second video signal to be applied to the plurality of video signal lines, and a control signal input unit for receiving n control signals transmitted from an outside, the inspection method comprising:
an inspection preparation step of enabling the operation control unit to apply the second video signal to the plurality of video signal lines; and
an m-line write step of changing levels of m signals out of the n control signals such that m (m is a natural number smaller than n) switches out of the n first switches included in the first demultiplexer provided corresponding to each grouped video signal line and m switches out of the n second switches included in the second demultiplexer provided corresponding to each grouped video signal line are maintained in an on state in a predetermined period, when a signal level of the second video signal is at a predetermined first level, wherein
when an any control signal out of the n control signals is defined as a target control signal, for each grouped video signal line, a video signal line connected to a first switch which is set to an on state by the target control signal and a video signal line connected to a second switch which is set to an on state by the target control signal are different.

### Effects of the Invention

According to the first aspect of the present invention, in the display panel in which the first demultiplexer including the first switches is provided at one end side of the video signal lines and the second demultiplexer including the second switches is provided at the other end side of the video signal lines, when an any control signal out of n control signals for controlling states of the switches which constitute the demultiplexers is defined as a target control signal, a video signal line connected to a first switch which is set to an on state by the target control signal and a video signal line connected to a second switch which is set to an on state by the target control signal are different. Therefore, in the case where a first switch that has an open failure is present in the first demultiplexer, when switches that constitute each demultiplexer are set to an on state based on one of the n control signals (that is, the target control signal), not only the first switch that has the open failure but also a first switch that is controlled by the target control signal is set to an on state As a result, a voltage of a second video signal to be basically applied to only one of the n video signals that constitute a set of grouped video signal lines may be provided to a plurality of video signal lines, and charge accumulated in one video signal line may be distributed to a plurality of video signal lines. Therefore, when performing a panel inspection in which a first video signal is not provided from an outside, an open failure of a first switch can be detected. Further, when the switches that constitute each demultiplexer are set to an on state based on a plurality of control signals out of the n control signals, a different display is performed depending on whether a first switch that has a close failure is present in the first demultiplexer or not. Accordingly, a close failure of a first switch can be detected when performing a panel inspection. According to a configuration of the present invention, because presence or absence of a failure is determined based on a display state of an image, a device or the like that measures a voltage value, for example, is not necessary. Thus, a display panel that can also detect, when performing a panel inspection, a failure of a first switch (a sampling switch) which operates in a normal-period, can be realized, without increasing a circuit scale.

According to the second aspect of the present invention, an effect similar to that of the first aspect of the present invention is obtained, in the display panel in which the operation control unit adapted to switch whether to allow a second video signal to be applied to the video signal line, is realized by a relatively small number of switches.

According to the third aspect of the present invention, a display panel in which an effect similar to that of the first aspect of the present invention is obtained is realized, without increasing a picture frame area in a direction (a direction to which scanning signal lines are extended) perpendicular to a direction to which the video signal lines are extended.

According to the fourth aspect of the present invention, a display panel in which an effect similar to that of the first aspect of the present invention is obtained is realized, without increasing a picture frame area in a direction (a direction to which scanning signal lines are extended) perpendicular to a direction to which the video signal lines are extended.

According to the fifth aspect of the present invention, because a common signal is provided to the input unit of all second demultiplexers in the display panel, an increase in a circuit scale can be suppressed.

According to the sixth aspect of the present invention, an effect similar to that of the first aspect of the present invention is obtained, in the display panel in which thin-film transistors are employed for switches that constitute a demultiplexer.

According to the seventh aspect of the present invention, a display module that includes a display panel which obtains an effect similar to that of the first aspect of the present invention is realized.

According to the eighth aspect of the present invention, when an inspection is performed on the display panel in which the first demultiplexer including the first switches is provided at one end side of the video signal lines and the second demultiplexer including the second switches is provided at the other end side of the video signal lines, in the case where a first switch that has an open failure is not present in the first demultiplexer, a voltage of a predetermined first level is applied to a video signal line corresponding to a display color to be tested, and a voltage of a predetermined second level is applied to a video signal line corresponding to a display color not to be tested. On the other hand, in the case where a first switch that has an open failure is present in the first demultiplexer, application of a voltage other than the first level to a video signal line corresponding to a display color to be tested and application of a voltage other than the second level to a video signal line corresponding to a display color not to be tested may occur. Accordingly, when performing a panel inspection, it also becomes possible to detect an open failure of a first switch (a sampling switch) that operates in a normal-period.

According to the ninth aspect of the present invention, when an inspection is performed on the display panel in which the first demultiplexer including first switches is provided at one end side of the video signal lines and a second demultiplexer including second switches is provided at the other end side of the video signal lines, potentials of the plurality of video signal lines after writing of a second video signal to the plurality of video signal lines are different depending on whether a first switch that has a close failure is present in the first demultiplexer or not. Accordingly, when performing a panel inspection, it also becomes possible to detect a close failure of a first switch (a sampling switch) that operates in a normal-period.

### BRIEF DESCRIPTION OF THE DRAWINGS

FIG. 1 is a circuit diagram showing configurations of a first distribution circuit and a second distribution circuit that are included in a liquid crystal panel according to a first embodiment of the present invention.

FIG. 2 is a block diagram showing a configuration of relevant parts of the liquid crystal panel according to the first embodiment.

FIG. 3 is a block diagram showing a state that a source driver is mounted on the liquid crystal panel in the first embodiment.

FIG. 4 is a circuit diagram showing a detailed configuration of the first distribution circuit in the first embodiment.

FIG. 5 is a circuit diagram showing a detailed configuration of the second distribution circuit in the first embodiment.

FIG. 6 is a signal waveform diagram showing waveforms of distribution control signals, a switching control signal, normal-use distribution control signals, and inspection-use distribution control signals, in an inspection-period and in a normal-period in the first embodiment.

FIG. 7 is a diagram showing a relationship of distribution control signals that are set to a high level with source bus lines to which data is written in a normal-period and source bus lines to which data is written in an inspection-period in the first embodiment.

FIG. 8 is a signal waveform diagram for describing a panel inspection for detecting an open failure in the first embodiment.

FIG. 9 is a signal waveform diagram showing a change of potentials of source bus lines when a test of red display is performed in the first embodiment.

FIG. 10 is a diagram for describing an operation when a sampling switch has an open failure in the first embodiment.

FIG. 11 is a signal waveform diagram showing a change of potentials of source bus lines when a test of green display is performed in the first embodiment.

FIG. 12 is a signal waveform diagram showing a change of potentials of source bus lines when a test of blue display is performed in the first embodiment.

FIG. 13 is a signal waveform diagram for describing a panel inspection for detecting a close failure in the first embodiment.

FIG. 14 is a signal waveform diagram showing a change of potentials of source bus lines when an R/B write test is performed in the first embodiment.

FIG. 15 is a signal waveform diagram showing a change of potentials of source bus lines when an R/G write test is performed in the first embodiment.

FIG. 16 is a signal waveform diagram showing a change of potentials of source bus lines when a G/B write test is performed in the first embodiment.

FIG. 17 is a circuit diagram showing a configuration of a modification of the first embodiment.

FIG. 18 is a circuit diagram showing a configuration of another modification of the first embodiment.

FIG. 19 is a circuit diagram showing configurations of a first distribution circuit and a second distribution circuit that are included in a liquid crystal panel according to a second embodiment of the present invention.

FIG. 20 is a diagram showing a relationship of distribution control signals that are set to a high level with source bus lines to which data is written in a normal-period, and source bus lines to which data is written in an inspection-period in the second embodiment.

FIG. 21 is a signal waveform diagram for describing a panel inspection for detecting an open failure in the second embodiment.

FIG. 22 is a signal waveform diagram showing a change of potentials of source bus lines when a test of red display is performed in the second embodiment.

FIG. 23 is a signal waveform diagram showing a change of potentials of source bus lines when a test of green display is performed in the second embodiment.

FIG. 24 is a signal waveform diagram showing a change of potentials of source bus lines when a test of blue display is performed in the second embodiment.

FIG. 25 is a signal waveform diagram for describing a panel inspection for detecting a close failure in the second embodiment.

FIG. 26 is a signal waveform diagram showing a change of potentials of source bus lines when an R/B write test is performed in the second embodiment.

FIG. 27 is a signal waveform diagram showing a change of potentials of source bus lines when an R/G write test is performed in the second embodiment.

FIG. 28 is a signal waveform diagram showing a change of potentials of source bus lines when a G/B write test is performed in the second embodiment.

FIG. 29 is a signal waveform diagram for describing a drive method of a liquid crystal panel according to a third embodiment of the present invention.

FIG. 30 is a signal waveform diagram for describing a driving method of a liquid crystal panel according to a modification of the third embodiment.

FIG. 31 is a block diagram showing a configuration of relevant parts of a conventional liquid crystal panel that includes a test circuit.

FIG. 32 is a circuit diagram showing a configuration of a first distribution circuit, a second distribution circuit, and a switching circuit, in a conventional example.

FIG. 33 is a diagram showing a relationship of distribution control signals that are set to a high level with source bus lines to which data is written in a normal-period, and source bus lines to which data is written in an inspection-period, in the conventional example.

### MODES FOR CARRYING OUT THE INVENTION

Embodiments of the present invention are described below with reference to the accompanying drawings.

### 1. First Embodiment

### 1. 1 Overall Configuration

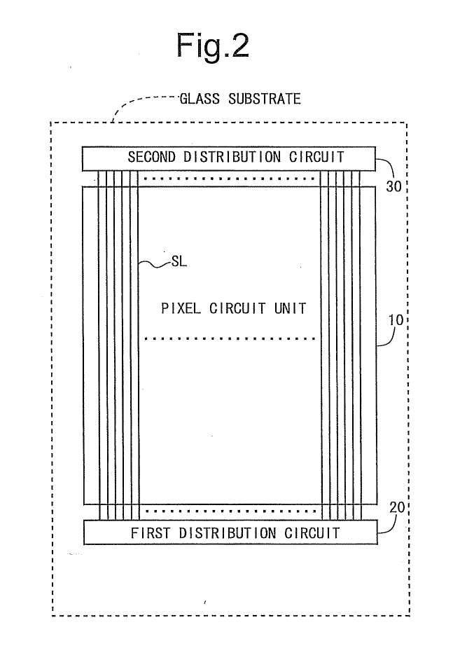

FIG. 2 is a block diagram showing a configuration of relevant parts of a liquid crystal panel according to a first embodiment of the present invention. As shown in FIG. 2, the liquid crystal panel is configured by a pixel circuit unit 10 as a region in which an image is displayed, a first distribution circuit 20 and a second distribution circuit 30 that each have a function of outputting a signal transmitted from an outside to a plurality of signal lines while switching output destinations. The pixel circuit unit 10, the first distribution circuit 20, and the second distribution circuit 30 are formed on one glass substrate (in general, called an “array substrate”) out of two glass substrates that constitute the liquid crystal panel.

The pixel circuit unit 10 includes a plurality of source bus lines (video signal lines) SL, a plurality of gate bus lines (scanning signal lines), and a plurality of pixel formation portions that are provided at respective intersections of the source bus lines SL and the gate bus lines. FIG. 2 shows only the source bus lines SL out of constituent elements of the pixel circuit unit 10. Each pixel formation portion includes a thin-film transistor (TFT) which is a switching element having a gate terminal connected to a gate bus line passing through a corresponding intersection and having a source terminal connected to the source bus line SL passing through the intersection; a pixel electrode that is connected to a drain terminal of the thin-film transistor; a common electrode which is a counter electrode that is provided in common to the plurality of pixel formation portions; and a liquid crystal layer that is provided in common to the plurality of pixel formation portions and is sandwiched between the pixel electrode and the common electrode. The first distribution circuit 20 and the second distribution circuit 30 are described in detail later.

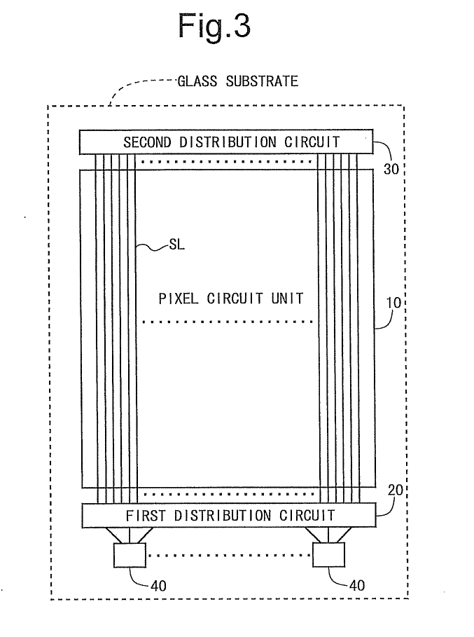

After an inspection (a panel inspection) for checking the presence or absence of defects of a liquid crystal panel ends, mounting of a driver IC (a driver integrated circuit) for driving the liquid crystal panel is performed. A liquid crystal module is manufactured by mounting the driver IC on the liquid crystal panel. In the present embodiment, after the panel inspection ends, source drivers 40 for driving the source bus lines SL are mounted in a form of an IC chip on a glass substrate as shown in FIG. 3. That is, in the present embodiment, a COG (Chip On Glass) method is employed as a mounting method of the IC chip. The present invention can be also applied to a liquid crystal panel that employs a mounting method, such as a COF (Chip On Film) method in which an IC chip is mounted on an FPC (Flexible Printed Circuit), other than the COG method. As for a gate driver for driving a gate bus line, there are a gate driver that is monolithically formed in advance on a glass substrate, and a gate driver that is mounted on a glass substrate in a form of an IC chip in a manner similar to that of the source driver. However, since the gate driver is not directly relevant to the present invention, their description and drawings are omitted.

The source drivers 40 drive the source bus lines SL based on data signals and timing signals that are transmitted from a control circuit at an outside of the liquid crystal panel (a PCB that is attached to a liquid crystal panel, for example). Note that, at a time point of performing a panel inspection described later, because a liquid crystal module is not in a completed state, that is, because the source drivers 40 are not yet mounted on the glass substrate, the source bus lines SL are not driven by the source drivers 40.

### 1. 2 Configuration and Operation of Distribution Circuit

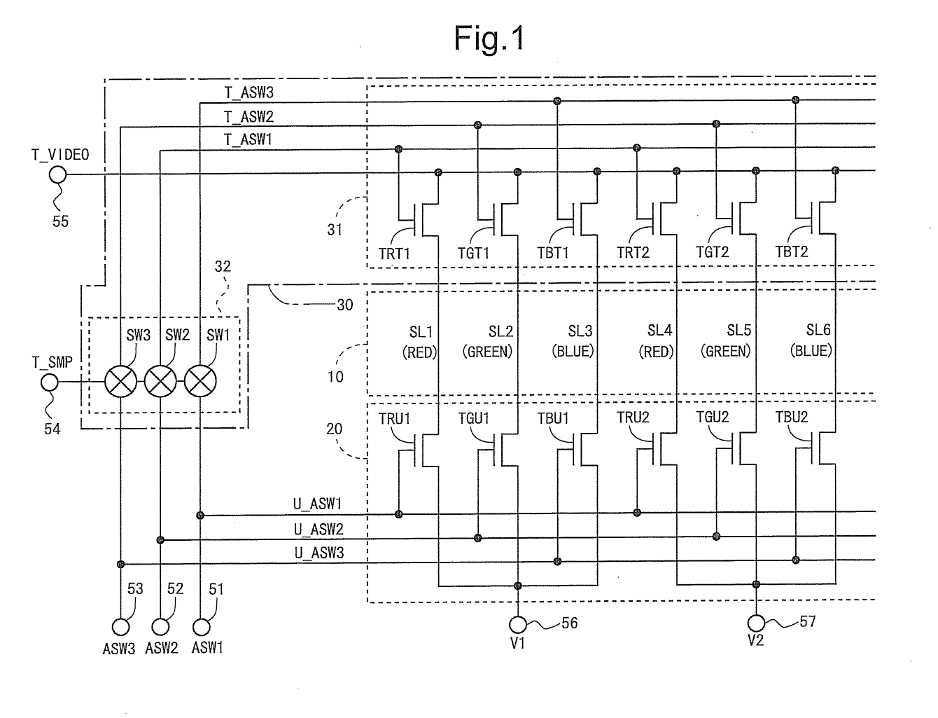

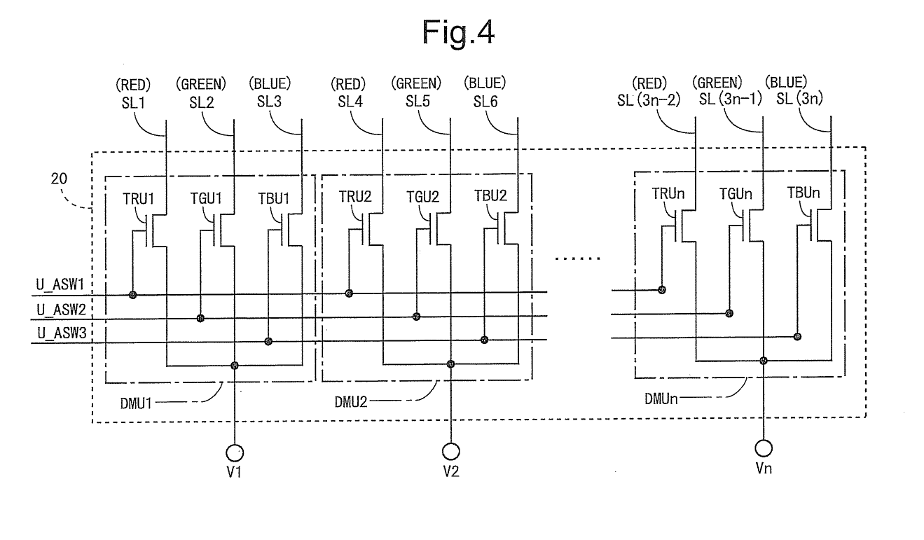

FIG. 1 is a circuit diagram showing configurations of the first distribution circuit 20 and the second distribution circuit 30. Herein, FIG. 1 shows only six source bus lines SL1 to SL6 out of a plurality of source bus lines. The first distribution circuit 20 includes a plurality of demultiplexers that output one input signal to a plurality of signal lines while switching output destinations. Specifically, as shown in FIG. 4, a one-input and three-output demultiplexer is provided for every three source bus lines for red, green, and blue. Because each demultiplexer has one input and three outputs, each demultiplexer includes three switches (thin-film transistors, for example). These switches are hereinafter referred to as “sampling switches”.

As shown in FIG. 4, mutually different input signals are provided to a plurality of demultiplexers DMU1, DMU2, . . . , DMUn in the first distribution circuit 20. For example, a video signal V1 is provided to the demultiplexer DMU1 that is provided corresponding to the source bus lines SL1 to SL3, a video signal V2 is provided to the demultiplexer DMU2 that is provided corresponding to the source bus lines SL4 to SL6, and a video signal Vn is provided to the demultiplexer DMUn that is provided corresponding to the source bus lines SL(3n-2) to SL(3n). On/off states of sampling switches TRU1, TRU2, . . . , TRUn that are provided corresponding to the source bus lines SL1, SL4, SL(3n-2) for red are controlled by a control signal U_ASW1, on/off states of sampling switches TGU1, TGU2, . . . , TGUn that are provided corresponding to the source bus lines SL2, SL5, . . . , SL(3n-1) for green are controlled by a control signal U_ASW2, and on/off states of sampling switches TBU1, TBU2, . . . , TBUn that are provided corresponding to the source bus lines SL3, SL6, . . . , SL(3n) for blue are controlled by a control signal U_ASW3.

The video signals V1 to Vn are transmitted from the source drivers 40 described above. Therefore, during a period when a panel inspection is performed in a state that the source drivers 40 are not yet mounted on the glass substrate, the video signals V1 to Vn are not provided to the demultiplexers DMU1 to DMUn. In FIG. 1, reference characters 56, 57 are assigned to input terminals for receiving the video signals V1, V2 that are transmitted from the source drivers 40.

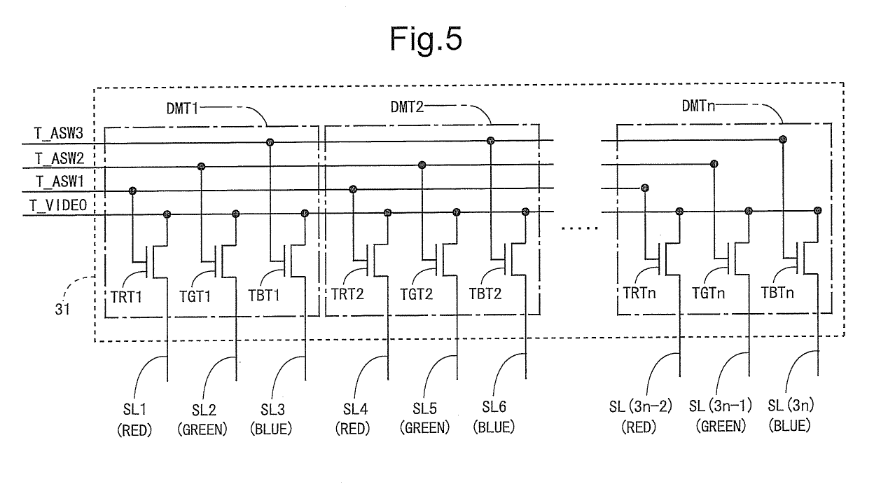

The second distribution circuit 30 is configured by a distribution unit 31 that is configured by a plurality of demultiplexers, and an operation control unit 32 that controls transmission of a signal to the distribution unit 31. In the distribution unit 31, as shown in FIG. 5, a one-input and three-output demultiplexer is provided for every three source bus lines for red, green, and blue, like the first distribution circuit 20. Each demultiplexer includes three switches (thin-film transistors, for example). These switches are hereinafter referred to as “test switches”.

In the second distribution circuit 30, a common (one) test video signal T_VIDEO is provided, as an input signal, to the plurality of demultiplexers DMT1, DMT2, . . . , DMTn, unlike in the first distribution circuit 20. The test video signal T_VIDEO is provided from an outside to an input terminal indicated by a reference character 55 in FIG. 1. On/off states of test switches TRT1, TRT2, . . . , TRTn that are provided corresponding to the source bus lines SL1, SL4, . . . , SL(3n-2) for red are controlled by a control signal T_ASW1, on/off states of test switches TGT1, TGT2, . . . , TGTn that are provided corresponding to the source bus lines SL2, SL5, . . . , SL(3n-1) for green are controlled by a control signal T_ASW2, and on/off states of test switches TBT1, TBT2, . . . , TBTn that are provided corresponding to the source bus lines SL3, SL6, . . . , SL(3n) for blue are controlled by a control signal T_ASW3

As shown in FIG. 1, the operation control unit 32 includes three switches SW1 to SW3 for controlling transmission of a signal to the distribution unit 31. On/off states of the three switches SW1 to SW3 are controlled by a control signal (a switching control signal) T_SMP that is provided from an outside to an input terminal indicated by a reference character 54. In the present embodiment, when the control signal T_SMP is at a high level, the switches SW1 to SW3 become in an on state, and when the control signal T_SMP is at a low level, the switches SW1 to SW3 become in an off state.

Input terminals 51 to 53 are provided on the glass substrate on which the first distribution circuit 20 and the second distribution circuit 30 are formed, as shown in FIG. 1, and the control signals ASW1 to ASW3 are provided to the input terminals 51 to 53. The control signal ASW1 is provided to the first distribution circuit 20 as the control signal U_ASW1, and is also provided to the distribution unit 31 in the second distribution circuit 30 as the control signal T_ASW3 when the switch SW1 is in an on state. The control signal ASW2 is provided to the first distribution circuit 20 as the control signal U_ASW2, and is also provided to the distribution unit 31 in the second distribution circuit 30 as the control signal T_ASW1 when the switch SW2 is in an on state. The control signal ASW3 is provided to first distribution circuit 20 as the control signal U_ASW3, and is also provided to the distribution unit 31 in the second distribution circuit 30 as the control signal T_ASW1 when the switch SW3 is in an on state.

In the configuration described above, on/off states of the three switches SW1 to SW3 are switched between the inspection-period and the normal-period. Thus, an operation performed in the inspection-period and an operation performed in the normal-period are different from each other. This is described below.

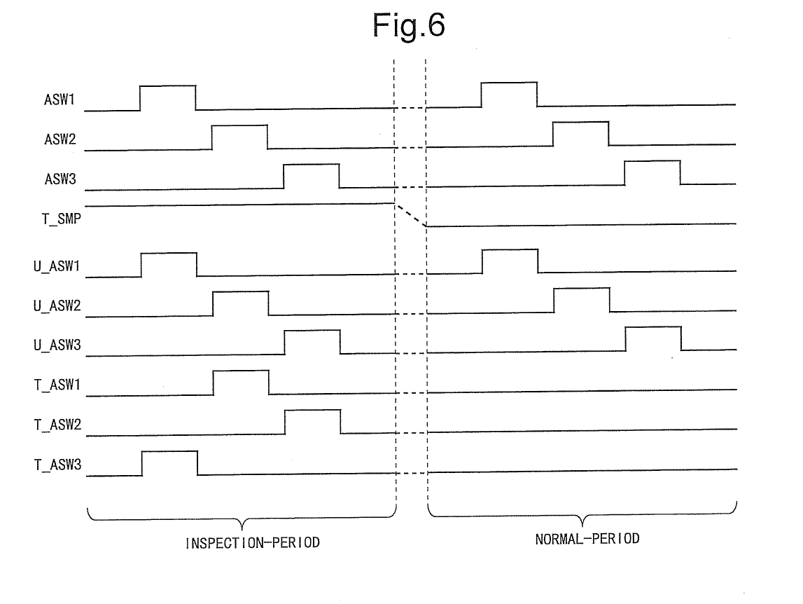

FIG. 6 is a signal waveform diagram showing waveforms of distribution control signals, a switching control signal, normal-use distribution control signals, and an inspection-use distribution control signals, in an inspection-period and in a normal-period. As shown in FIG. 6, the control signal T_SMP is maintained at a high level in an inspection-period, and is maintained at a low level in a normal-period. Therefore, the switches SW1 to SW3 in the operation control unit 32 are maintained in an on state in an inspection-period, and are maintained in an off state in a normal-period. Accordingly, in an inspection-period, the control signals U_ASW1, T_ASW3 are at a high level in a period when the control signal ASW1 is at a high level, the control signals U_ASW2, T_ASW1 are at a high level in a period when the control signal ASW2 is at a high level, and the control signals U_ASW3, T_ASW2 are at a high level in a period when the control signal ASW3 is at a high level. On the other hand, in a normal-period, only the control signal U_ASW1 is at a high level in a period when the control signal ASW1 is at a high level, only the control signal U_ASW2 is at a high level in a period when the control signal ASW2 is at a high level, and only the control signal U_ASW3 is at a high level in a period when the control signal ASW3 is at a high level.

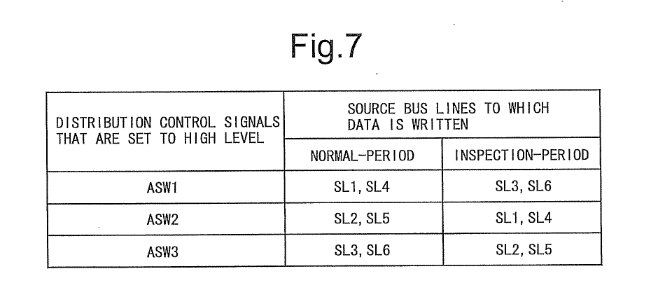

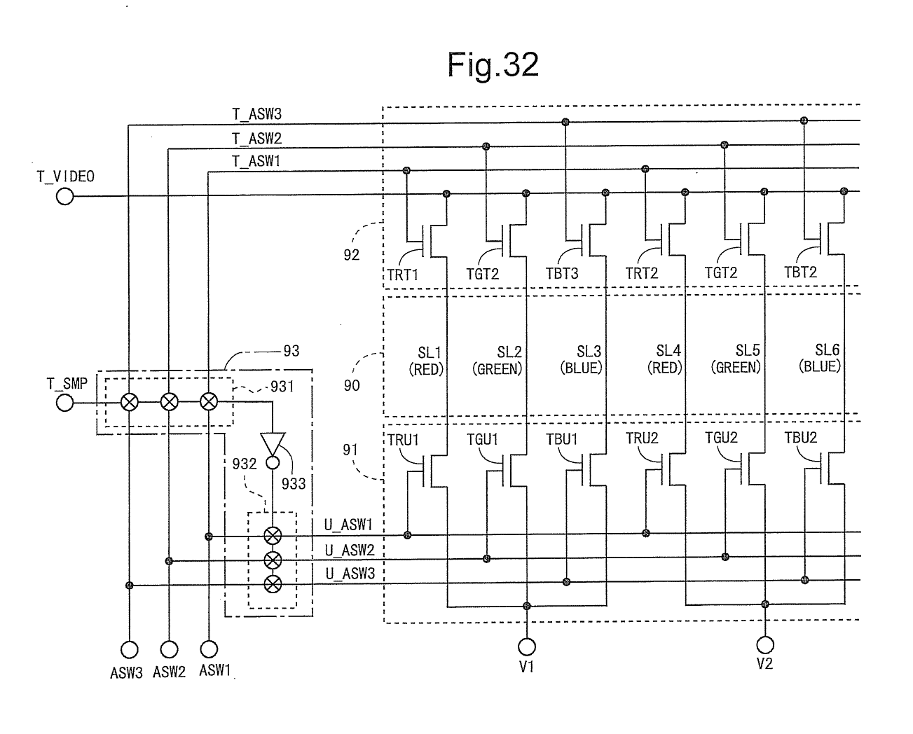

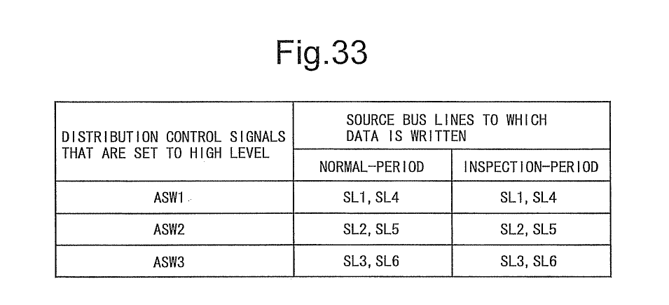

Considering that a video signal is not provided to the first distribution circuit 20 in an inspection-period (because the source drivers 40 are not present), a relationship of distribution control signals that are set to a high level with source bus lines to which data is written in a normal-period and source bus lines to which data is written in an inspection-period is as shown in FIG. 7. According to the conventional configuration, when attention is focused on a case where a certain distribution control signal becomes at a high level, source bus lines to which data is written in a normal-period are the same as source bus lines to which data is written in an inspection-period, as shown in FIG. 32. On the other hand, according to the present embodiment, when attention is focused on a case where a certain distribution control signal becomes at a high level, source bus lines to which data is written in a normal-period are different from source bus lines to which data is written in an inspection-period.

In the present embodiment, a set of grouped video signal lines is configured by three source bus lines for red, green, and blue. In the present embodiment, a first demultiplexer is realized by a demultiplexer in the first distribution circuit 20, a second demultiplexer is realized by a demultiplexer in the second distribution circuit 30, a first switch is realized by a sampling switch, and a second switch is realized by a test switch.

### 1. 3 Inspection Method of Liquid Crystal Panel

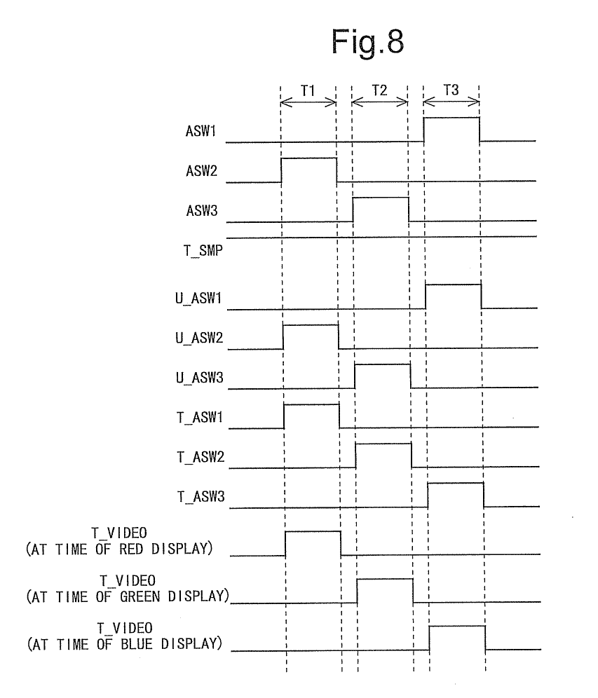

An inspection method of a liquid crystal panel according to the present embodiment is described next with reference to FIG. 8 to FIG. 16. First, a panel Inspection method for detecting an open failure of a sampling switch is described, and a panel inspection method for detecting a close failure of a sampling switch is described next. The open failure refers to a state that a sampling switch cannot be set to an off state (that is, always in an on state), and the close failure refers to a state that a sampling switch cannot be set to an on state (that is, always in an off state). Regarding a panel inspection described below, it is assumed that “before writing of the test video signal T_VIDEO is performed, a potential of a source bus line is at an intermediate gradation level”. A description is made below by focusing attention on the source bus lines SL1 to SL3, the sampling switches TRU1, TGU1, and TBU1, and the test switches TRT1, TGT1, and TBT1.

### 1. 3. 1 Panel Inspection Method for Detecting Open Failure

When performing a panel inspection for detecting an open failure, distribution control signals are set to a high level in a predetermined period, in an order of ASW2, ASW3, ASW1, for example, as shown in FIG. 8. Hereinafter, periods that are indicated by reference characters T1, T2, and T3 in FIG. 8 are called a first period, a second period, and a third period, respectively. The switching control signal T_SMP is maintained at a high level during a period when a panel inspection is being performed, as described above. Accordingly, regarding normal-use distribution control signals, U_ASW2 becomes at a high level in the first period T1, U_ASW3 becomes at a high level in the second period T2, and U_ASW1 becomes at a high level in the third period T3. Regarding inspection-use distribution control signals, T_ASW1 becomes at a high level in the first period T1, T_ASW2 becomes at a high level in the second period T2, and T_ASW3 becomes at a high level in the third period T3. This inspection includes a test of red display, a test of green display, and a test of blue display. As shown in FIG. 8, when performing the test of red display, the test video signal T_VIDEO is set to a high level in only the first period T1, when performing the test of green display, the test video signal T_VIDEO is set to a high level in only the second period T2, and when performing the test of blue display, the test video signal T_VIDEO is set to a high level in only the third period T3. When a voltage of a common electrode is set to 0V, a voltage of the test video signal T_VIDEO is set to 5V when the test video signal T_VIDEO is at a high level, and is set to 0V when the test video signal T_VIDEO is at a low level.

### 1. 3. 1. 1 Test of Red Display

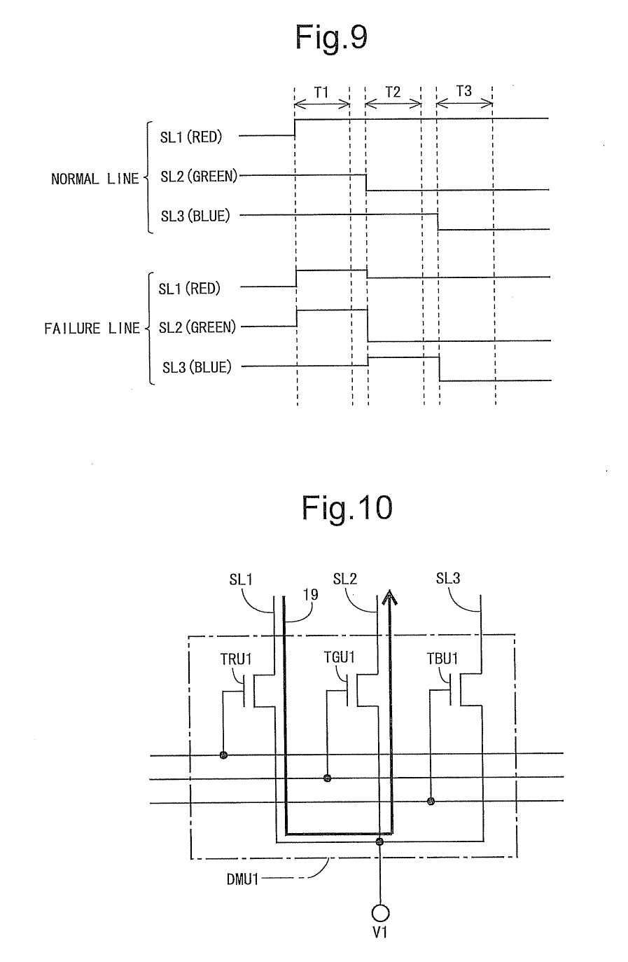

FIG. 9 is a signal waveform diagram showing a change of potentials of the source bus lines SL1 to SL3 when the test of red display is performed. In this case, as described above, the test video signal T_VIDEO is set to a high level in only the first period T1.

When an open failure is not present in a sampling switch, the following operation is performed. In the first period T1, because the control signals T_ASW1, U_ASW2 become at a high level, the test switch TRT1 and the sampling switch TGU1 become in an on state. Accordingly, the test video signal T_VIDEO at a high level is provided to the source bus line SL1 via the test switch TRT1. In the second period T2, because the control signals T_ASW2, U_ASW3 become at a high level, the test switch TGT1 and the sampling switch TBU1 become in an on state. Accordingly, the test video signal T_VIDEO at a low level is provided to the source bus line SL2 via the test switch TGT1. In the third period T3, because the control signals T_ASW3, U_ASW1 become at a high level, the test switch TBT1 and the sampling switch TRU1 become in an on state. Accordingly, the test video signal T_VIDEO at a low level is provided to the source bus line SL3 via the test switch TBT1. In this way, at a time point when the third period T3 ends, the source bus line SL1 is in a state of being applied with a voltage of a high level, and the source bus lines SL2, SL3 are in a state of being applied with a voltage of a low level. As a result, red display is performed in a region of lines that include only normal sampling switches.

When an open failure is present in a sampling switch, the following operation is performed. In this case, it is assumed that the sampling switch TRU1 has an open failure. In the first period T1, because the control signals T_ASW1, U_ASW2 become at a high level, the test switch TRT1 and the sampling switch TGU1 become in an on state. Accordingly, the test video signal T_VIDEO at a high level is provided to the source bus line SL1 via the test switch TRT1. Because it is assumed that the sampling switch TRU1 has an open failure, the sampling switch TRU1 also becomes in an on state in the first period T1. Accordingly, as shown by an arrowhead indicated by a reference character 19 in FIG. 10, the test video signal T_VIDEO at a high level is provided from the source bus line SL1 to the source bus line SL2, via the sampling switches TRU1, TGU1. In the second period T2, because the control signals T_ASW2, U_ASW3 become at a high level, the test switch TGT1 and the sampling switch TBU1 become in an on state. Accordingly, the test video signal T_VIDEO at a low level is applied to the source bus line SL2 via the test switch TGT1. Because the sampling switch TRU1 is also in an on state, charge is distributed between the source bus line SL1 and the source bus line SL3, via the sampling switches TRU1, TBU1. As a result, a potential of the source bus line SL1 decreases, and a potential of the source bus line SL3 increases. In the third period T3, because the control signals T_ASW3, U_ASW1 become at a high level, the test switch TBT1 and the sampling switch TRU1 become in an on state. Accordingly, the test video signal T_VIDEO at a low level is applied to the source bus line SL3 via the test switch TBT1. In this way, at a time point when the third period T3 ends, the source bus line SL1 is in a state of being applied with a voltage of an intermediate level, and the source bus lines SL2, SL3 are in a state of being applied with a voltage of a low level. As a result, red display is not performed and a gray display is performed, in a region of lines in which a sampling switch that has an open failure is present.

### 1. 3. 1. 2 Test of Green Display

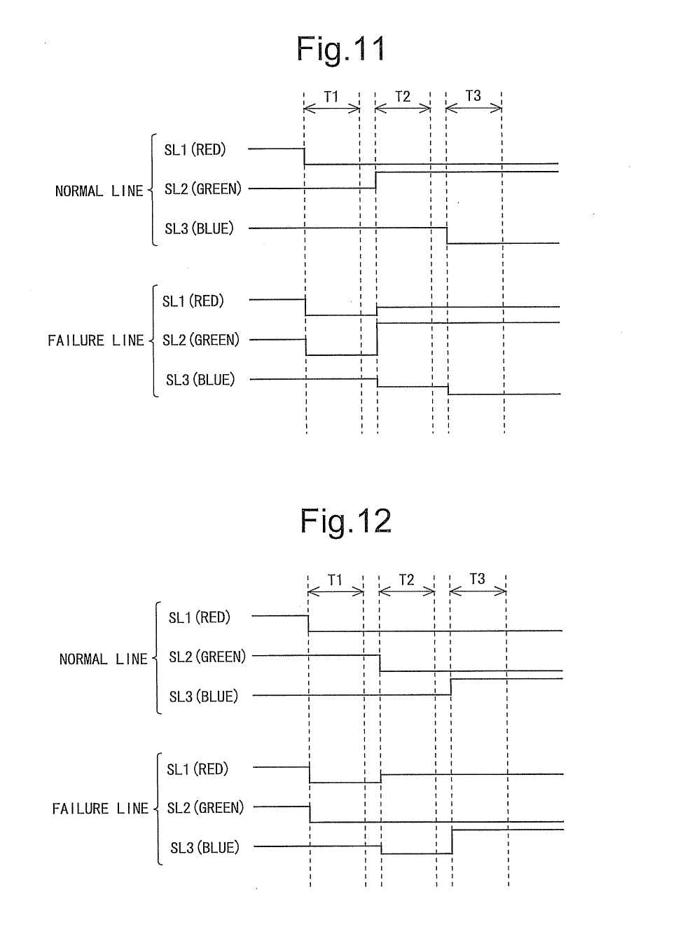

FIG. 11 is a signal waveform diagram showing a change of potentials of the source bus lines SL1 to SL3 when the test of green display is performed. In this case, the test video signal T_VIDEO is set to a high level in only the second period T2, as described above.

When an open failure is not present in a sampling switch, the following operation is performed. In the first period T1, because the control signals T_ASW1, U_ASW2 become at a high level, the test switch TRT1 and the sampling switch TGU1 become in an on state. Accordingly, the test video signal T_VIDEO at a low level is applied to the source bus line SL1 via the test switch TRT1. In the second period T2, because the control signals T_ASW2, U_ASW3 become at a high level, the test switch TGT1 and the sampling switch TBU1 become in an on state. Accordingly, the test video signal T_VIDEO at a high level is applied to the source bus line SL2 via the test switch TGT1. In the third period T3, because the control signals T_ASW3, U_ASW1 become at a high level, the test switch TBT1 and the sampling switch TRU1 become in an on state. Accordingly, the test video signal T_VIDEO at a low level is applied to the source bus line SL3 via the test switch TBT1. In this way, at a time point when the third period T3 ends, the source bus lines SL1, SL3 are in a state of being applied with a voltage of a low level, and the source bus line SL2 is in a state of being applied with a voltage of a high level. As a result, green display is performed in a region of lines that include only normal sampling switches.

When an open failure is present in a sampling switch, the following operation is performed. In this case, it is assumed that the sampling switch TRU1 has an open failure. In the first period T1, because the control signals T_ASW1, U_ASW2 become at a high level, the test switch TRT1 and the sampling switch TGU1 become in an on state. Accordingly, the test video signal T_VIDEO at a low level is applied to the source bus line SL1 via the test switch TRT1. Because it is assumed that the sampling switch TRU1 has an open failure, the sampling switch TRU1 also becomes in an on state in the first period T1. Accordingly, the test video signal T_VIDEO at a low level is applied from the source bus line SL1 to the source bus line SL2, via the sampling switches TRU1, TGU1. In the second period T2, because the control signals T_ASW2, U_ASW3 become at a high level, the test switch TGT1 and the sampling switch TBU1 become in an on state. Accordingly, the test video signal T_VIDEO at a high level is applied to the source bus line SL2 via the test switch TGT1. Because the sampling switch TRU1 is also in an on state, charge is distributed between the source bus line SL1 and the source bus line SL3, via the sampling switches TRU1, TBU1. As a result, a potential of the source bus line SL1 increases, and a potential of the source bus line SL3 decreases. In the third period T3, because the control signals T_ASW3, U_ASW1 become at a high level, the test switch TBT1 and the sampling switch TRU1 become in an on state. Accordingly, the test video signal T_VIDEO at a low level is applied to the source bus line SL3 via the test switch TBT1. In this way, at a time point when the third period T3 ends, the source bus line SL1 is in a state of being applied with a voltage of an intermediate level, the source bus line SL2 is in a state of being applied with a voltage of a high level, and the source bus line SL3 is in a state of being applied with a voltage of a low level. As a result, green display is not performed in a region of lines in which a sampling switch that has an open failure is present.

### 1. 3. 1. 3 Test of Blue Display

FIG. 12 is a signal waveform diagram showing a change of potentials of the source bus lines SL1 to SL3 when the test of blue display is performed. In this case, the test video signal T_VIDEO is set to a high level in only the third period T3, as described above.

When an open failure is not present in a sampling switch, the following operation is performed. In the first period T1, because the control signals T_ASW1, U_ASW2 become at a high level, the test switch TRT1 and the sampling switch TGU1 become in an on state. Accordingly, the test video signal T_VIDEO at a low level is applied to the source bus line SL1 via the test switch TRT1. In the second period T2, because the control signals T_ASW2, U_ASW3 become at a high level, the test switch TGT1 and the sampling switch TBU1 become in an on state. Accordingly, the test video signal T_VIDEO at a low level is applied to the source bus line SL2 via the test switch TGT1. In the third period T3, because the control signals T_ASW3, U_ASW1 become at a high level, the test switch TBT1 and the sampling switch TRU1 become in an on state. Accordingly, the test video signal T_VIDEO at a high level is applied to the source bus line SL3 via the test switch TBT1. In this way, at a time point when the third period T3 ends, the source bus lines SL1, SL2 are in a state of being applied with a voltage of a low level, and the source bus line SL3 is in a state of being applied with a voltage of a high level. As a result, blue display is performed in a region of lines that include only normal sampling switches.

When an open failure is present in a sampling switch, the following operation is performed. In this case, it is assumed that the sampling switch TRU1 has an open failure. In the first period T1, because the control signals T_ASW1, U_ASW2 become at a high level, the test switch TRT1 and the sampling switch TGU1 become in an on state. Accordingly, the test video signal T_VIDEO at a low level is applied to the source bus line SL1 via the test switch TRT1. Because it is assumed that the sampling switch TRU1 has an open failure, the sampling switch TRU1 also becomes in an on state in the first period T1. Accordingly, the test video signal T_VIDEO at a low level is provided from the source bus line SL1 to the source bus line SL2, via the sampling switches TRU1, TGU1. In the second period T2, because the control signals T_ASW2, U_ASW3 become at a high level, the test switch TGT1 and the sampling switch TBU1 become in an on state. Accordingly, the test video signal T_VIDEO at a high level is applied to the source bus line SL2 via the test switch TGT1. Because the sampling switch TRU1 is also in an on state, charge is distributed between the source bus line SL1 and the source bus line SL3, via the sampling switches TRU1, TBU1. As a result, a potential of the source bus line SL1 increases, and a potential of the source bus line SL3 decreases. In the third period T3, because the control signals T_ASW3, U_ASW1 become at a high level, the test switch TBT1 and the sampling switch TRU1 become in an on state. Accordingly, the test video signal T_VIDEO at a high level is applied to the source bus line SL3 via the test switch TBT1. In this way, at a time point when the third period T3 ends, the source bus line SL1 is in a state of being applied with a voltage of an intermediate level, the source bus line SL2 is in a state of being applied with a voltage of a low level, and the source bus line SL3 is in a state of being applied with a voltage of a high level. As a result, blue display is not performed in a region of lines in which a sampling switch that has an open failure is present.

### 1. 3. 1. 4 Conclusion

As described above, in a region of lines that include only normal sampling switches, all of red display, green display, and blue display are normally performed. On the other hand, in a region of lines in which a sampling switch that has an open failure is present, none of red display, green display, and blue display is normally performed, or a part of these displays is not normally performed. Accordingly, an open failure of sampling switches can be detected.

### 1. 3. 2 Panel Inspection Method for Detecting Close Failure

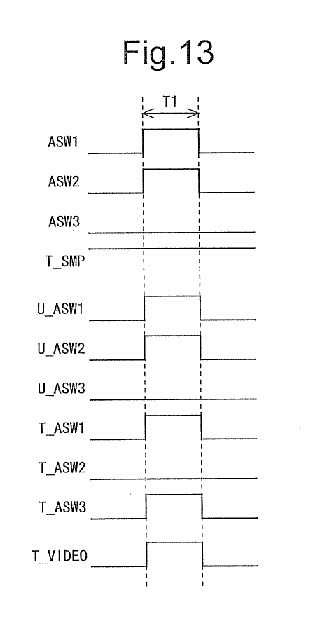

When performing a panel inspection for detecting a close failure, any two of the distribution control signals ASW1 to ASW3 are set to a high level in a predetermined period (the first period T1). FIG. 13 shows a signal waveform diagram when ASW1 and ASW2 out of the distribution control signals are set to a high level in the first period T1. The switching control signal T_SMP is maintained at a high level during a period when a panel inspection is being performed, as described above. Accordingly, in the first period T1, two normal-use distribution control signals and two inspection-use distribution control signals that correspond to the distribution control signals which are set to a high level become at a high level. The test video signal T_VIDEO is set to a high level in the first period T1. This inspection includes a write test that is performed to source bus lines for red and blue (hereinafter, referred to as an “R/B write test”), a write test that is performed to source bus lines for red and green (hereinafter, referred to as an “R/G write test”), and a write test that is performed to source bus lines for green and blue (hereinafter, referred to as a “G/B write test”)

### 1. 3. 2. 1 R/B Write Test

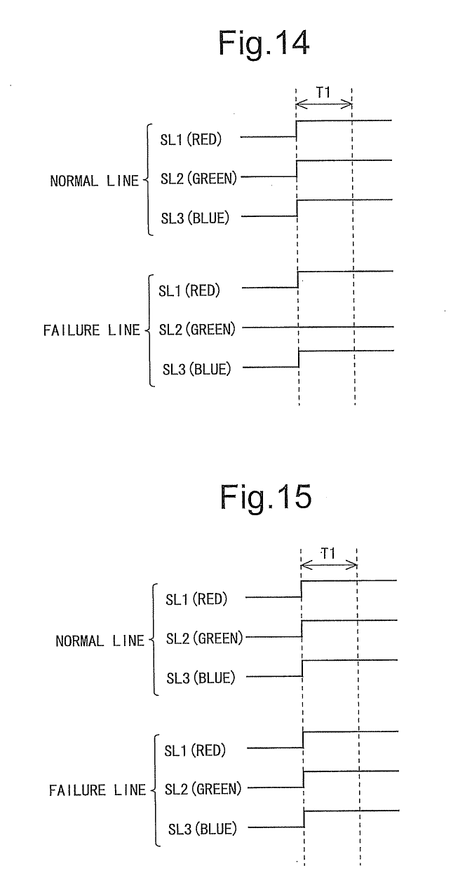

FIG. 14 is a signal waveform diagram showing a change of potentials of the source bus lines SL1 to SL3 when an R/B write test is performed. In this case, in the first period T1, ASW1 and ASW2 out of the distribution control signals are set to a high level.

When a close failure is not present in a sampling switch, the following operation is performed. In the first period T1, because T_ASW1, T_ASW3 become at a high level as for the inspection-use distribution control signals, the test switches TRT1, TBT1 become in an on state. Accordingly, the test video signal T_VIDEO at a high level is applied to the source bus lines SL1, SL3 via the test switches TRT1, TBT1. In the first period T1, because U_ASW1, U_ASW2 become at a high level as for the normal-use distribution control signals, the sampling switches TRU1, TGU1 become in an on state. Accordingly, the test video signal T_VIDEO at a high level is also applied to the source bus line SL2 from the source bus line SL1 via the sampling switches TRU1, TGU1. In a manner as described above, at a time point when the first period T1 ends, the source bus lines SL1 to SL3 are in a state of being applied with a voltage of a high level. As a result, white display is performed in a region of lines that include only normal sampling switches.

When a close failure is present in a sampling switch, the following operation is performed. In this case, it is assumed that the sampling switch TRU1 has a close failure. In the first period T1, in a similar manner to that when a sampling switch has no close failure, the test switches TRT1, TBT1 become in an on state, and the test video signal T_VIDEO at a high level is applied to the source bus lines SL1, SL3. In the first period T1, although U_ASW1 and U_ASW2 become at a high level as for the normal-use distribution control signals, because it is assumed that the sampling switch TRU1 has a close failure, only the sampling switch TGU1 becomes in an on state. In this case, because the sampling switches TRU1, TBU1 are in an off state, the test video signal T_VIDEO is not applied to the source bus line SL2. In this way, at a time point when the first period T1 ends, the source bus lines SL1, SL3 are in a state of being applied with a voltage of a high level, and the source bus line SL2 is in a state of being applied with a voltage of an intermediate level. As a result, white display is not performed in a region of lines in which a sampling switch of a close failure is present.

### 1. 3. 2. 2 R/G Write Test

FIG. 15 is a signal waveform diagram showing a change of potentials of the source bus lines SL1 to SL3 when an R/G write test is performed. In this case, in the first period T1, ASW2 and ASW3 out of the distribution control signals are set to a high level.

When a close failure is not present in a sampling switch, the following operation is performed. In the first period T1, because T_ASW1, T_ASW2 become at a high level as for the inspection-use distribution control signals, the test switches TRT1, TGT1 become in an on state. Accordingly, the test video signal T_VIDEO at a high level is applied to the source bus lines SL1, SL2 via the test switches TRT1, TGT1. In the first period T1, because U_ASW2, U_ASW3 become at a high level as for the normal-use distribution control signals, the sampling switches TGU1, TBU1 become in an on state. Accordingly, the test video signal T_VIDEO at a high level is also applied to the source bus line SL3 from the source bus line SL2 via the sampling switches TGU1, TBU1. In a manner as described above, at a time point when the first period T1 ends, the source bus lines SL1 to SL3 are in a state of being applied with a voltage of a high level. As a result, white display is performed in a region of lines that include only normal sampling switches.

When a close failure is present in a sampling switch, the following operation is performed. In this case, it is assumed that the sampling switch TRU1 has a close failure. In the first period T1, in a similar manner to that when a sampling switch has no close failure, the test switches TRT1, TGT1 become in an on state, and the test video signal T_VIDEO at a high level is applied to the source bus lines SL1, SL2. In the first period T1, because U_ASW2, U_ASW3 become at a high level as for the normal-use distribution control signals, in a similar manner to that when a sampling switch has no close failure, the test video signal T_VIDEO at a high level is also provided to the source bus line SL3 from the source bus line SL2 via the sampling switches TGU1, TBU1. In this way, at a time point when the first period T1 ends, the source bus lines SL1 to SL3 are in a state of being applied with a voltage of a high level. As a result, regarding this test, white display is performed, in spite of presence of a sampling switch that has a close failure.

### 1. 3. 2. 3 G/B Write Test

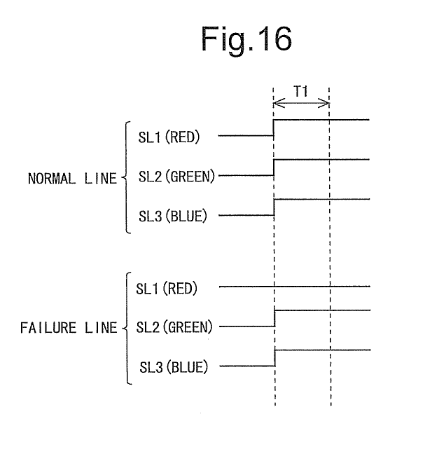

FIG. 16 is a signal waveform diagram showing a change of potentials of the source bus lines SL1 to SL3 when a G/B write test is performed. In this case, in the first period T1, ASW1 and ASW3 out of the distribution control signals are set to a high level.

When a close failure is not present in a sampling switch, the following operation is performed. In the first period T1, because T_ASW2, T_ASW3 become at a high level as for the inspection-use distribution control signals, the test switches TGT1, TGBT1 become in an on state. Accordingly, the test video signal T_VIDEO at a high level is applied to the source bus lines SL2, SL3 via the test switches TGT1, TBT1. In the first period T1, because U_ASW1, U_ASW3 become at a high level as for the normal-use distribution control signals, the sampling switches TRU1, TBU1 become in an on state. Accordingly, the test video signal T_VIDEO at a high level is also applied to the source bus line SL1 from the source bus line SL3 via the sampling switches TBU1, TRU1. In a manner as described above, at a time point when the first period T1 ends, the source bus lines SL1 to SL3 are in a state of being applied with a voltage of a high level. As a result, white display is performed in a region of lines that include only normal sampling switches.

When a close failure is present in a sampling switch, the following operation is performed. In this case, it is assumed that the sampling switch TRU1 has a close failure. In the first period T1, in a similar manner to that when a sampling switch has no close failure, the test switches TGT1, TBT1 become in an on state, and the test video signal T_VIDEO at a high level is applied to the source bus lines SL2, SL3. In the first period T1, although U_ASW1, U_ASW3 become at a high level as for the normal-use distribution control signals, because it is assumed that the sampling switch TRU1 has a close failure, only the sampling switch TBU1 becomes in an on state. In this case,, because the sampling switches TRU1, TGU1 are in an off state, the test video signal T_VIDEO is not applied to the source bus line SL1. In this way, at a time point when the first period T1 ends, the source bus lines SL2, SL3 are in a state of being applied with a voltage of a high level, and the source bus line SL1 is in a state of being applied with a voltage of an intermediate level. As a result, white display is not performed in a region of lines in which a sampling switch that has a close failure is present.

### 1. 3. 2. 4 Conclusion

As described above, in the region of lines that include only normal sampling switches, white display is performed in all of the R/B write test, the R/G write test, and the G/B write test. On the other hand, in the region of lines in which the sampling switch that has the close failure is present, white display is not performed in all of or in a part of the R/B write test, the R/G write test, and the G/B write test. Accordingly, a close failure of a sampling switch can be detected.

### 1. 4 Effect

According to the present embodiment, when an any signal out of three distribution control signals for controlling on/off states of a sampling switch and a test switch is defined as a target control signal, a source bus line that is connected to a sampling switch which is set to an on state by the target control signal is different from a source bus line that is connected to a test switch which is set to an on state by the target control signal. Therefore, when a sampling switch and a test switch are set to an on state based on a certain distribution control signal when the test video signal T_VIDEO is at a high level, a voltage of a high level is applied to only one of three source bus lines that constitute a set of grouped video signal lines, in the case where a sampling switch that has an open failure is not present. On the other hand, in the case where a sampling switch that has an open failure is present, a voltage of a high level may be applied to two or more source bus lines out of the three source bus lines that constitute a set of grouped video signal lines, and charge that is accumulated in one source bus line may be distributed to two or more source bus lines. Accordingly, an open failure of a sampling switch can be detected when performing a panel inspection. When a sampling switch and a test switch are set to an on state based on two distribution control signals when the test video signal T_VIDEO is at a high level, a voltage of a high level is applied to all of the three source bus lines that constitute a set of grouped video signal lines, in the case where a sampling switch that has a close failure is not present. On the other hand, in the case where a sampling switch that has a close failure is present, there is a possibility that a voltage of a high level is applied to only two source bus lines out of the three source bus lines that constitute a set of grouped video signal lines. More specifically, in the case where a sampling switch that has a close failure is present, when a sampling switch and a test switch are set to an on state based on all combinations of two distribution control signals out of the three distribution control signals when the test video signal T_VIDEO is at a high level, there occurs without exception that a voltage of a high level is applied to only two source bus lines out of the three source bus lines that constitute a set of grouped video signal lines. Accordingly, a close failure of a sampling switch can be detected when performing a panel inspection.

As can be understood from FIG. 1 (a circuit diagram in the present embodiment) and FIG. 32 (a circuit diagram in the conventional example), according to the present embodiment, a circuit scale does not become larger than that in the conventional example. Therefore, a picture frame of the panel can be set smaller. Further, because sampling switches are disposed at one end side of source bus lines and because test switches are disposed at the other end side of the source bus lines, a picture frame at a sampling switch side (a source driver side) based on the display unit (the pixel circuit unit) can be set smaller.

### 1. 5 Modification

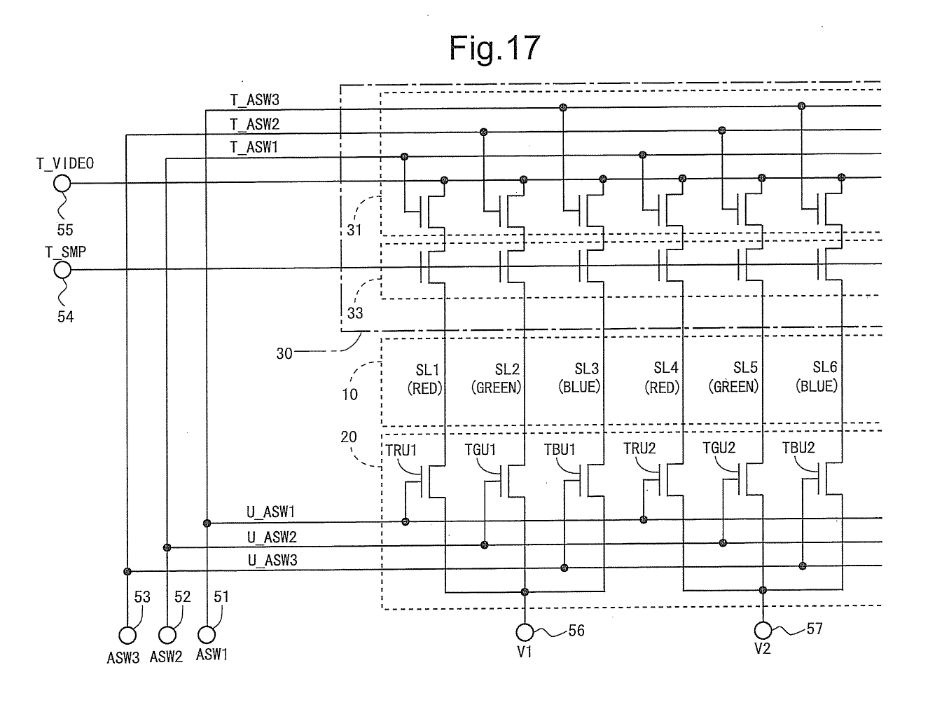

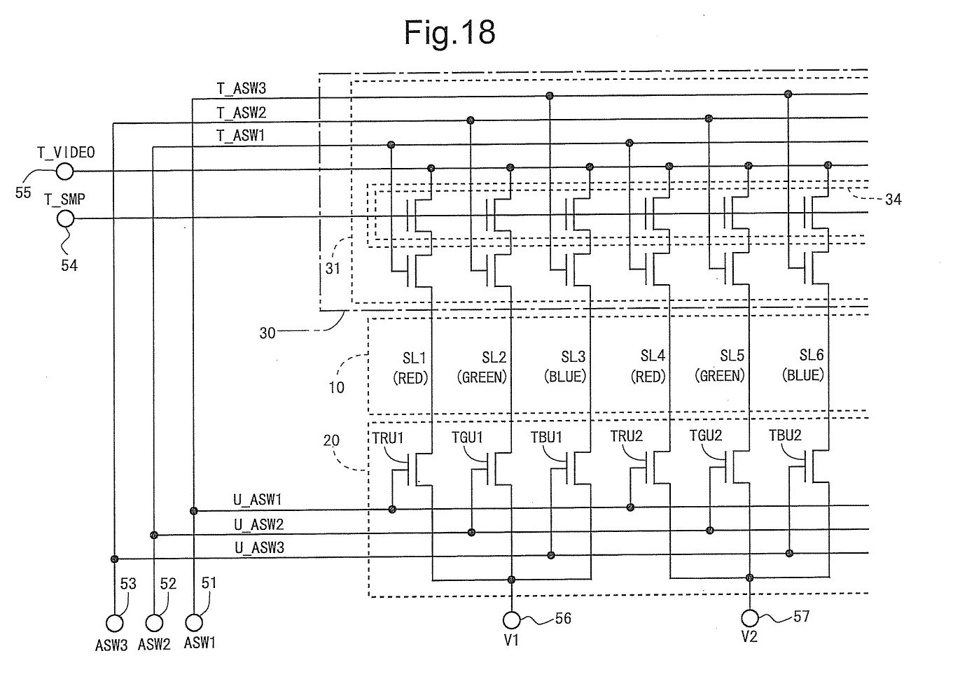

In the first embodiment, output of the test video signal T_VIDEO to source bus lines is controlled by controlling transmission of inspection-use distribution control signals that are provided to the distribution unit 31 in the second distribution circuit 30, by the three switches SW1 to SW3, however, the present invention is not limited thereto. For example, the configuration may be such that, as indicated by a reference character 33 in FIG. 17, switches (thin-film transistors, for example) for controlling output of the test video signal T_VIDEO to source bus lines are provided between the distribution unit 31 and the pixel circuit unit 10. Alternatively, the configuration may be such that, in place of the configuration shown in FIG. 17, switches (thin-film transistors, for example) for controlling transmission of the test video signal T_VIDEO are provided between a signal line for transmitting the test video signal T_VIDEO and sampling switches in the distribution unit 31, as indicated by a reference character 34 in FIG. 18. In the configuration shown in FIG. 17, an operation control unit is realized by a plurality of switches in a region indicated by the reference character 33. In the configuration shown in FIG. 18, an operation control unit is realized by a plurality of switches in a region indicated by the reference character 34.

According to the modification described above, as compared with the first embodiment, it is possible to realize a liquid crystal panel capable of also detecting a failure of a sampling switch that operates in a normal-period when performing a panel inspection, without increasing a picture frame area in a direction (a direction to which the gate bus lines are extended) perpendicular to a direction to which the source bus lines are extended.

### 2. Second Embodiment

### 2, 1 Configuration and Operation of Distribution Circuit

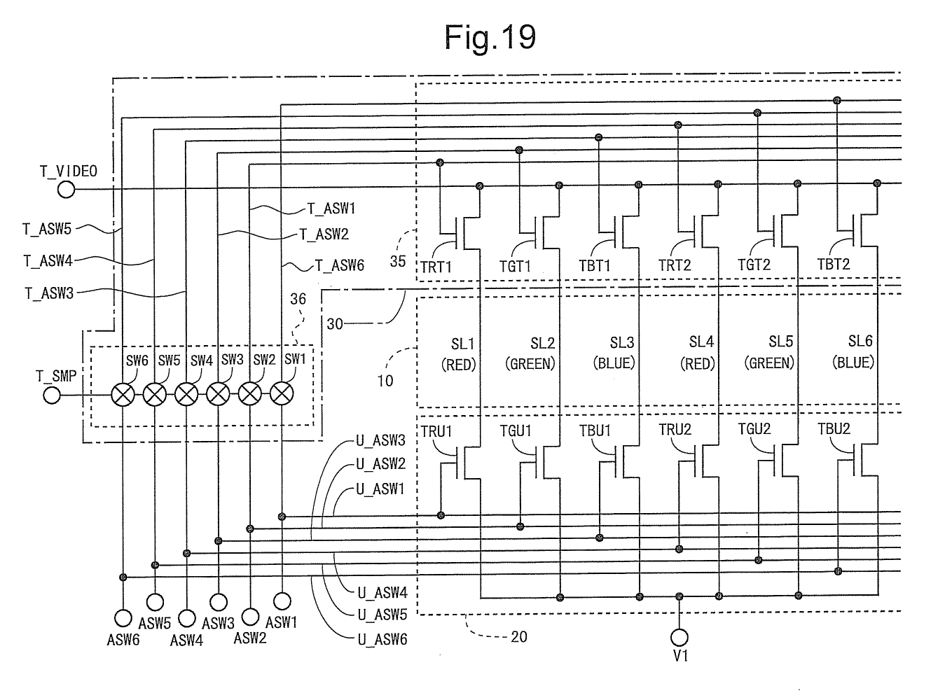

FIG. 19 is a circuit diagram showing detailed configurations of the first distribution circuit 20 and the second distribution circuit 30 according to a second embodiment of the present invention. FIG. 1 shows only six source bus lines SL1 to SL6 out of a plurality of source bus lines. Because an overall configuration of the liquid crystal panel is similar to that of the first embodiment, its description is omitted (see FIG. 2, FIG. 3). In the present embodiment, unlike in the first embodiment, a one-input and six-output demultiplexer is provided for every six source bus lines, in the first distribution circuit 20. Similarly, a one-input and six-output demultiplexer is provided for every six source bus lines, in a distribution unit 35 in the second distribution circuit 30. Focusing attention on constituent elements corresponding to the six source bus lines SL1 to SL6 shown in FIG. 19, six sampling switches TRU1, TGU1, TBU1, TRU2, TGU2, and TBU2 are provided in the first distribution circuit 20, and six test switches TRT1, TGT1, TBT1, TRT2, TGT2, and TBT2 are provided in the distribution unit 35 in the second distribution circuit 30. Because one-input and six-output demultiplexers are provided in the distribution unit 35, six switches SW1 to SW6 are provided in an operation control unit 36. On/off states of the six switches SW1 to SW6 are controlled by the control signal T_SMP transmitted from an outside, as in the first embodiment.

On/off states of the sampling switches TRU1, TGU1, TBU1, TRU2, TGU2, and TBU2 are controlled by control signals U_ASW1, U_ASW2, U_ASW3, U_ASW4, U_ASW5, and U_ASW6, respectively. On/off states of the test switches TRT1, TGT1, TBT1, TRT2, TGT2, and TBT2 are controlled by control signals T_ASW1, T_ASW2, T_ASW3, T_ASW4, T_ASW5, and T_ASW6, respectively.

In the present embodiment, distribution control signals ASW1 to ASW6 are provided from an outside. The distribution control signals ASW1, ASW2, ASW3, ASW4, ASW5, and ASW6 are provided to the first distribution circuit 20, as normal-use distribution control signals U_ASW1, U_ASW2, U_ASW3, U_ASW4, U_ASW5, and U_ASW6, respectively. The distribution control signals ASW1, ASW2, ASW3, ASW4, ASW5, and ASW6 are also provided to the distribution unit 35 in the second distribution circuit 30, as inspection-use distribution control signals T_ASW6, T_ASW1, T_ASW2, T_ASW3, T_ASW4, and T_ASW5, respectively, when the switches SW1 to SW6 in the operation control unit 36 are in an on state.

In the configuration described above, on/off states of the six switches SW1 to SW6 are switched between an inspection-period and a normal-period. Specifically, in an inspection-period, the control signal T_SMP is maintained at a high level, and thus the switches SW1 to SW6 are in an on state, and in a normal-period, the control signal T_SMP is maintained at a low level, and thus the switches SW1 to SW6 are in an off state. Accordingly, in an inspection-period, the control signals U_ASW1, T_ASW6 are at a high level in a period when the control signal ASW1 is at a high level, the control signals U_ASW2, T_ASW1 are at a high level in a period when the control signal ASW2 is at a high level, the control signals U_ASW3, T_ASW2 are at a high level in a period when the control signal ASW3 is at a high level, the control signals U_ASW4, T_ASW3 are at a high level in a period when the control signal ASW4 is at a high level, the control signals U_ASW5, T_ASW4 are at a high level in a period when the control signal ASW5 is at a high level, and the control signals U_ASW6, T_ASW5 are at a high level in a period when the control signal ASW6 is at a high level. On the other hand, in a normal-period, only the control signal U_ASW1 is at a high level in a period when the control signal ASW1 is at a high level, only the control signal U_ASW2 is at a high level in a period when the control signal ASW2 is at a high level, only the control signal U_ASW3 is at a high level in a period when the control signal ASW3 is at a high level, only the control signal U_ASW4 is at a high level in a period when the control signal ASW4 is at a high level, only the control signal U_ASW5 is at a high level in a period when the control signal ASW5 is at a high level, and only the control signal U_ASW6 is at a high level in a period when the control signal ASW6 is at a high level.

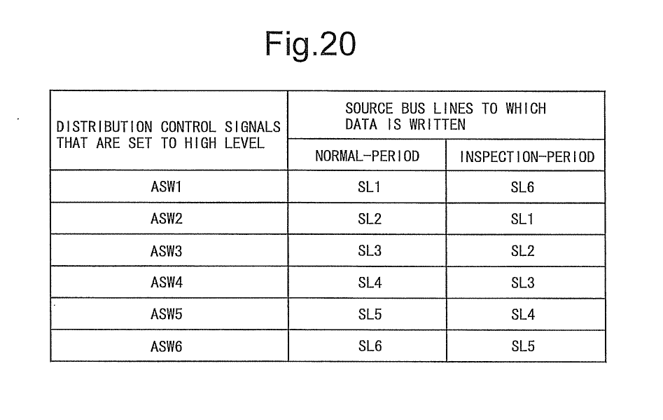

Considering that a video signal is not provided to the first distribution circuit 20 in an inspection-period (because the source drivers 40 are not present), a relationship of distribution control signals that are set to a high level with source bus lines to which data is written in a normal-period and source bus lines to which data is written in an inspection-period is as shown in FIG. 20. In this way, also in the present embodiment, focusing attention on a case where a certain distribution control signal becomes at a high level, source bus lines to which data is written in a normal-period are different from source bus lines to which data is written in an inspection-period.

### 2. 2 Inspection Method of Liquid Crystal Panel

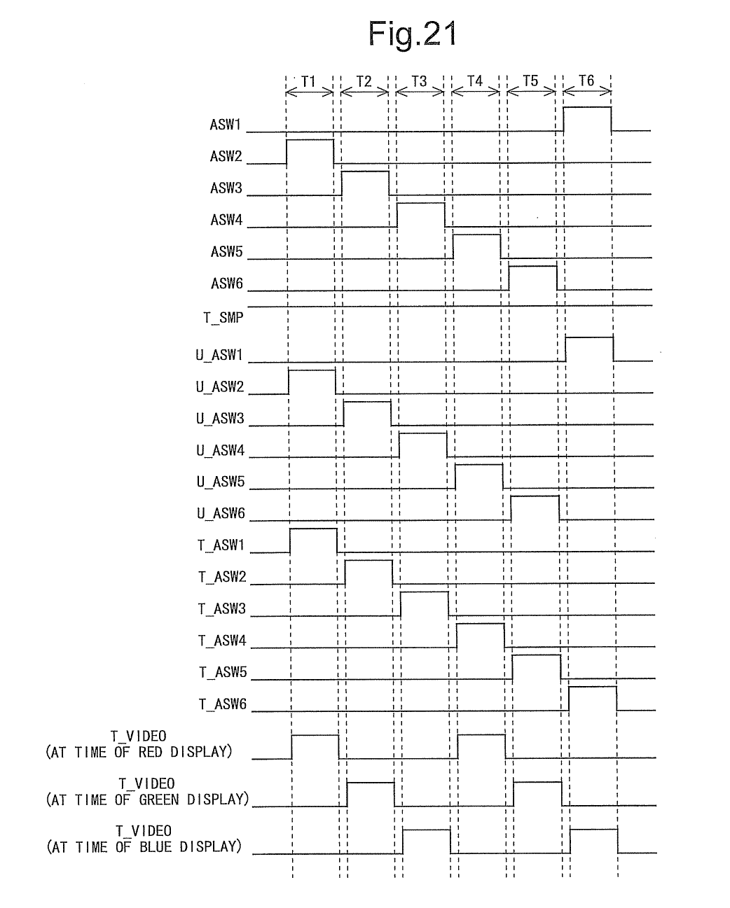

An inspection method of a liquid crystal panel according to the present embodiment is described next with reference to FIG. 21 to FIG. 28. Note that as in the first embodiment, regarding the following panel inspection, it is assumed that “before writing of the test video signal T_VIDEO is performed, a potential of a source bus line is at an intermediate gradation level”. A description is made below by focusing attention on the source bus lines SL1 to SL6, the sampling switches TRU1, TGU1, TBU1, TRU2, TGU2, and TBU2, and the test switches TRT1, TGT1, TBT1, TRT2, TGT2, and TBT2.

### 2. 2. 1 Panel Inspection Method for Detecting Open Failure

When performing a panel inspection for detecting an open failure, distribution control signals are set to a high level in a predetermined period, in an order of ASW2, ASW3, ASW4, ASW5, ASW6, and ASW1, for example, as shown in FIG. 21. Hereinafter, periods that are indicated by reference characters T1, T2, T3, T4, T5, and T6 in FIG. 21 are called a first period, a second period, a third period, a fourth period, a fifth period, and a sixth period, respectively. The switching control signal T_SMP is maintained at a high level during a period when a panel inspection is being performed, as described above. Accordingly, regarding normal-use distribution control signals, U_ASW2, U_ASW3, U_ASW4, U_ASW5, U_ASW6, and U_ASW1 become at a high level in the first period T1, the second period T2, the third period T3, the fourth period T4, the fifth period T5, and the sixth period T6, respectively. Regarding inspection-use distribution control signals, T_ASW1, T_ASW2, T_ASW3, T_ASW4, T_ASW5, and T_ASW6 become at a high level in the first period T1, the second period T2, the third period T3, the fourth period T4, the fifth period T5, and the sixth period T6, respectively. In the present embodiment, as shown in FIG. 21, when performing a test of red display, the test video signal T_VIDEO is set to a high level in the first period T1 and the fourth period T4, when performing a test of green display, the test video signal T_VIDEO is set to a high level in the second period T2 and the fifth period T5, and when performing a test of blue display, the test video signal T_VIDEO is set to a high level in the third period T3 and the sixth period T6.

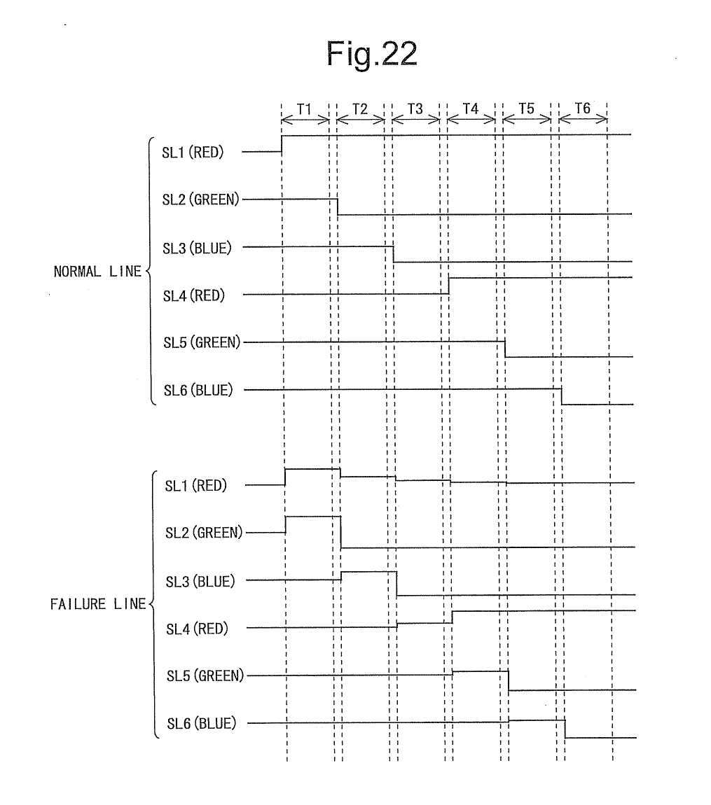

FIG. 22 is a signal waveform diagram showing a change of potentials of the source bus lines SL1 to SL6 when a test of red display is performed. In this case, as described above, the test video signal T_VIDEO becomes at a high level in the first period T1 and the fourth period T4.

When an open failure is not present in a sampling switch, the following operation is performed. In the first period T1, because the control signals T_ASW1, U_ASW2 become at a high level, the test switch TRT1 and the sampling switch TGU1 become in an on state. Accordingly, the test video signal T_VIDEO at a high level is applied to the source bus line SL1 via the test switch TRT1. In the second period T2, because the control signals T_ASW2, U_ASW3 become at a high level, the test switch TGT1 and the sampling switch TBU1 become in an on state. Accordingly, the test video signal T_VIDEO at a low level is applied to the source bus line SL2 via the test switch TGT1.

In the third period T3, because the control signals T_ASW3, U_ASW4 become at a high level, the test switch TBT1 and the sampling switch TRU2 become in an on state. Accordingly, the test video signal T_VIDEO at a low level is applied to the source bus line SL3 via the test switch TBT1. In the fourth period T4, because the control signals T_ASW4, U_ASW5 become at a high level, the test switch TRT2 and the sampling switch TGU2 become in an on state. Accordingly, the test video signal T_VIDEO at a high level is applied to the source bus line SL4 via the test switch TRT2. In the fifth period T5, because the control signals T_ASW5, U_ASW6 become at a high level, the test switch TGT2 and the sampling switch TBU2 become in an on state. Accordingly, the test video signal T_VIDEO at a low level is applied to the source bus line SL5 via the test switch TGT2. In the sixth period T6, because the control signals T_ASW6, U_ASW1 become at a high level, the test switch TBT2 and the sampling switch TBU1 become in an on state. Accordingly, the test video signal T_VIDEO at a low level is applied to the source bus line SL6 via the test switch TBT2. In this way, at a time point when the sixth period T6 ends, the source bus lines SL1, SL4 are in a state of being applied with a voltage of a high level, and the source bus lines SL2, SL3, SL5, and SL6 are in a state of being applied with a voltage of a low level. As a result, red display is performed in a region of lines that include only normal sampling switches.

When an open failure is present in a sampling switch, the following operation is performed. In this case, it is assumed that the sampling switch TRU1 has an open failure. In the first period T1, because the control signals T_ASW1, U_ASW2 become at a high level, the test switch TRT1 and the sampling switch TGU1 become in an on state. Accordingly, the test video signal T_VIDEO at a high level is applied to the source bus line SL1 via the test switch TRT1. Because it is assumed that the sampling switch TRU1 has an open failure, the sampling switch TRU1 also becomes in an on state in the first period T1. Accordingly, the test video signal T_VIDEO at a high level is applied from the source bus line SL1 to the source bus line SL2, via the sampling switches TRU1, TGU1. In the second period T2, because the control signals T_ASW2, U_ASW3 become at a high level, the test switch TGT1 and the sampling switch TBU1 become in an on state. Accordingly, the test video signal T_VIDEO at a low level is applied to the source bus line SL2 via the test switch TGT1. Because the sampling switch TRU1 is also in an on state, charge is distributed between the source bus line SL1 and the source bus line SL3, via the sampling switches TRU1, TBU1. As a result, a potential of the source bus line SL1 decreases, and a potential of the source bus line SL3 increases. In the third period T3, because the control signals T_ASW3, U_ASW4 become at a high level, the test switch TBT1 and the sampling switch TRU2 become in an on state. Accordingly, the test video signal T_VIDEO at a low level is applied to the source bus line SL3 via the test switch TBT1. Because the sampling switch TRU1 is also in an on state, charge is distributed between the source bus line SL1 and the source bus line SL4 via the sampling switches TRU1, TRU2. As a result, a potential of the source bus line SL1 decreases, and a potential of the source bus line SL4 increases. In the fourth period T4, because the control signals T_ASW4, U_ASW5 become at a high level, the test switch TRT2 and the sampling switch TGU2 become in an on state. Accordingly, the test video signal T_VIDEO at a high level is applied to the source bus line SL4 via the test switch TRT2. Because the sampling switch TRU1 is also in an on state, charge is distributed between the source bus line SL1 and the source bus line SL5 via the sampling switches TRU1, TGU2. As a result, a potential of the source bus line SL1 slightly decreases, and a potential of the source bus line SL5 slightly increases. In the fifth period T5, because the control signals T_ASW5, U_ASW6 become at a high level, the test switch TGT2 and the sampling switch TBU2 become in an on state. Accordingly, the test video signal T_VIDEO at a low level is applied to the source bus line SL5 via the test switch TGT2. Because the sampling switch TRU1 is also in an on state, charge is distributed between the source bus line SL1 and the source bus line SL6 via the sampling switches TRU1, TBU2. As a result, a potential of the source bus line SL1 slightly decreases, and a potential of the source bus line SL6 slightly increases. In the sixth period T6, because the control signals T_ASW6, U_ASW1 become at a high level, the test switch TBT2 and the sampling switch TRU1 become in an on state. Accordingly, the test video signal T_VIDEO at a low level is applied to the source bus line SL6 via the test switch TBT2. In this way, at a time point when the sixth period T6 ends, the source bus line SL1 is in a state of being applied with a voltage of an intermediate level, the source bus lines SL2, SL3, SL5, and SL6 are in a state of being applied with a voltage of a low level, and the source bus line SL4 is in a state of being applied with a voltage of a high level. As a result, red display is not performed in a region of lines in which a sampling switch that has an open failure is present.

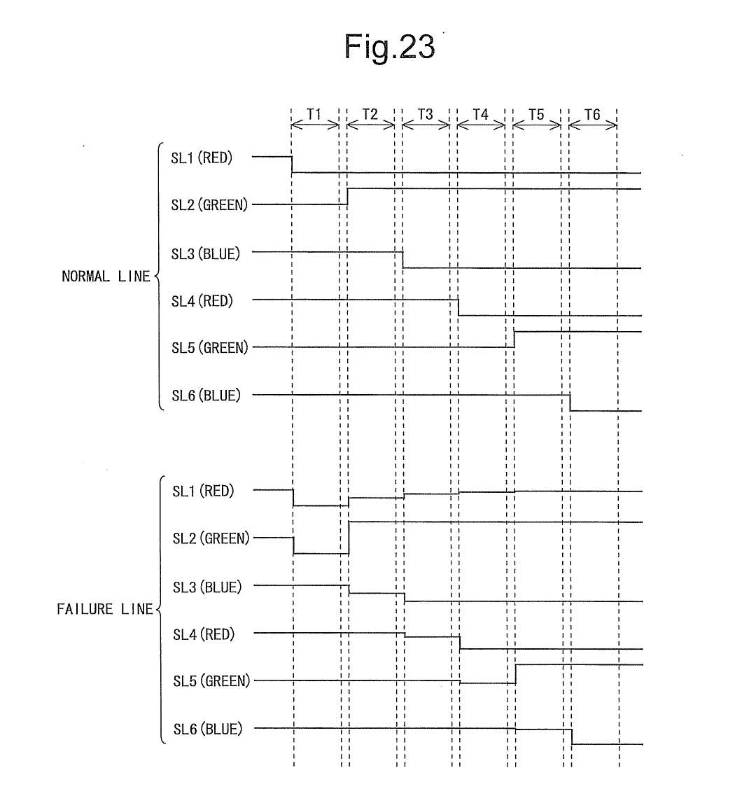

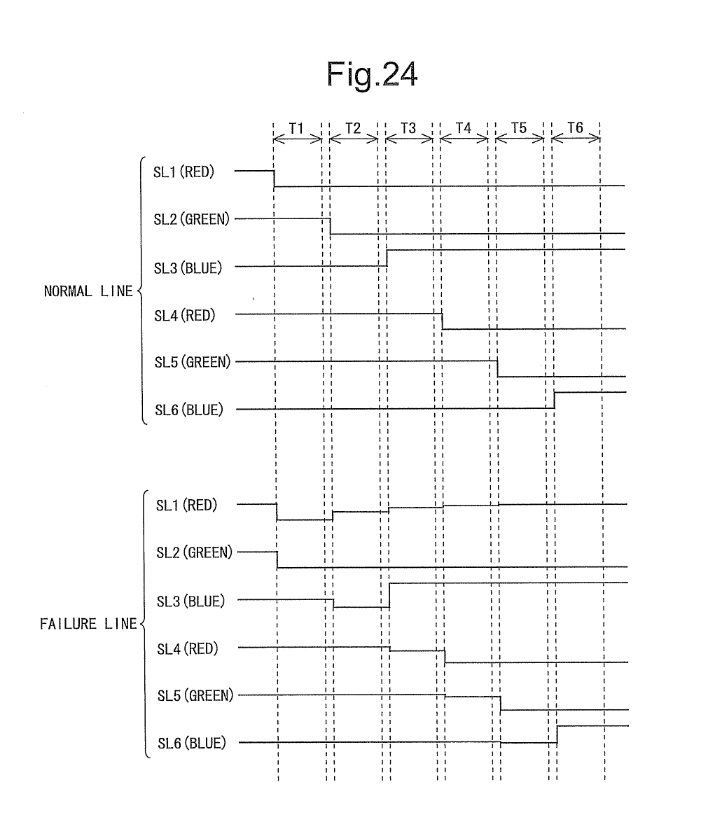

A test of green display and a test of blue display are performed in a manner similar to that of the test of red display, and therefore, their detailed description is omitted. FIG. 23 is a signal waveform diagram showing a change of potentials of the source bus lines SL1 to SL6 when the test of green display is performed, and FIG. 24 is a signal waveform diagram showing a change of potentials of the source bus lines SL1 to SL6 when the test of blue display is performed. In a region of lines in which a sampling switch that has an open failure is present, green display is not performed as a result of the test of green display, and blue display is not performed as a result of the test of blue display. In a manner as described above, an open failure of sampling switches can be also detected, in a configuration that one-input and six-output demultiplexers are provided in the first distribution circuit 20.

### 2. 2. 2 Panel Inspection Method for Detecting Close Failure

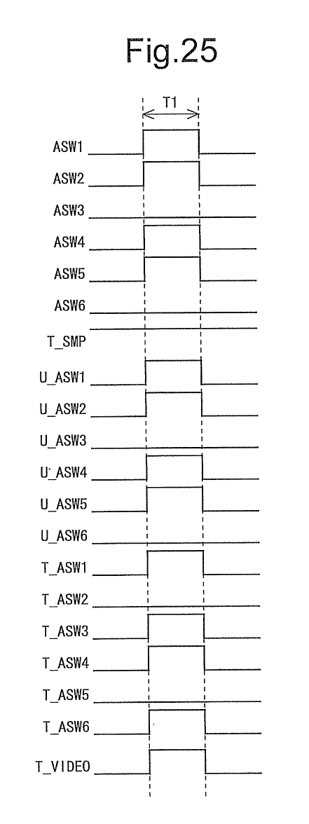

When performing a panel inspection for detecting a close failure, four distribution control signals out of distribution control signals ASW1 to ASW6 are set to a high level in a predetermined period (a first period T1). Specifically, when performing an R/B write test, ASW1, ASW2, ASW4, and ASW5 are set to a high level, when performing an R/G write test, ASW2, ASW3, ASW5, and ASW6 are set to a high level, and when performing a G/B write test, ASW1, ASW3, ASW4, and ASW6 are set to a high level. FIG. 25 shows a signal waveform diagram when ASW1, ASW2, ASW4, and ASW5 out of the distribution control signals are set to a high level in the first period T1. The switching control signal T_SMP is maintained at a high level during a period when a panel inspection is being performed, as described above. Accordingly, in the first period T1, four normal-use distribution control signals and four inspection-use distribution control signals corresponding to distribution control signals that are set to a high level become at a high level. The test video signal T_VIDEO is set to a high level in the first period T1.

### 2. 2. 2. 1 R/B Write Test

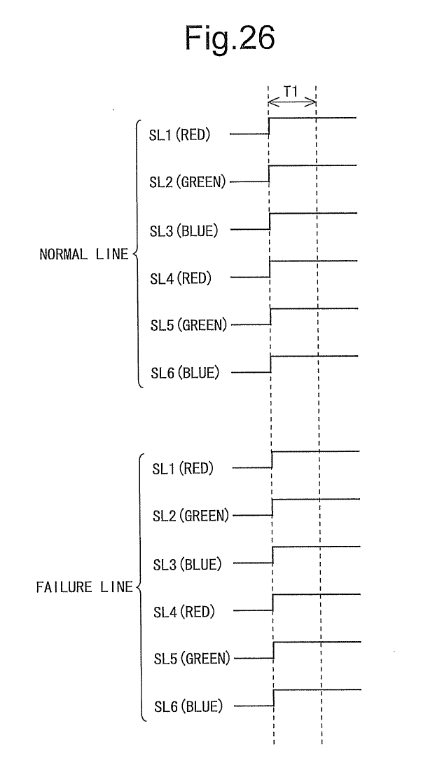

FIG. 26 is a signal waveform diagram showing a change of potentials of the source bus lines SL1 to SL6 when an R/B write test is performed. In this case, in the first period T1, out of the distribution control signals, ASW1, ASW2, ASW4, and ASW5 are set to a high level.

When a close failure is not present in a sampling switch, the following operation is performed. In the first period T1, because T_ASW1, T_ASW3, T_ASW4, and T_ASW6 become at a high level as for the inspection-use distribution control signals, the test switches TRT1, TBT1, TRT2, and TBT2 become in an on state. Accordingly, the test video signal T_VIDEO at a high level is applied to the source bus lines SL1, SL3, SL4, and SL6, via the test switches TRT1, TBT1, TRT2, and TBT2. In the first period T1, because U_ASW1, U_ASW2, U_ASW4, and U_ASW5 become at a high level as for the normal-use distribution control signals, the sampling switches TRU1, TGU1, TRU2, and TGU2 become in an on state. Accordingly, the test video signal T_VIDEO at a high level that is applied to the source bus lines SL1, SL4 is also applied to the source bus lines SL2, SL5 via sampling switches that are set to an on state. In this way, at a time point when the first period T1 ends, the source bus lines SL1 to SL6 are in a state of being applied with a voltage of a high level. As a result, white display is performed in a region of lines that include only normal sampling switches.

When a close failure is present in a sampling switch, the following operation is performed. In this case, it is assumed that the sampling switch TRU1 has a close failure. In the first period T1, in a similar manner to that when a sampling switch has no close failure, the test switches TRT1, TBT1, TRT2, and TBT2 become in an on state, and the test video signal T_VIDEO at a high level is applied to the source bus lines SL1, SL3, SL4, and SL6. In the first period T1, although U_ASW1, U_ASW2, U_ASW4, and U_ASW5 become at a high level as for the normal-use distribution control signals, because the sampling switch TRU1 is assumed to have a close failure, the sampling switches TGU1, TRU2, and TGU2 become in an on state. Accordingly, the test video signal T_VIDEO at a high level is also applied to the source bus line SL5 from the source bus line SL4 via the sampling switches TRU2, TGU2. Further, the test video signal T_VIDEO at a high level is also applied to the source bus line SL2 from the source bus line SL4 via the sampling switches TRU2, TGU1. In this way, at a time point when the first period T1 ends, the source bus lines SL1 to SL6 are in a state of being applied with a voltage of a high level. As a result, regarding this test, white display is performed, in spite of presence of a sampling switch that has a close failure.

### 2. 2. 2. 2 R/G Write Test

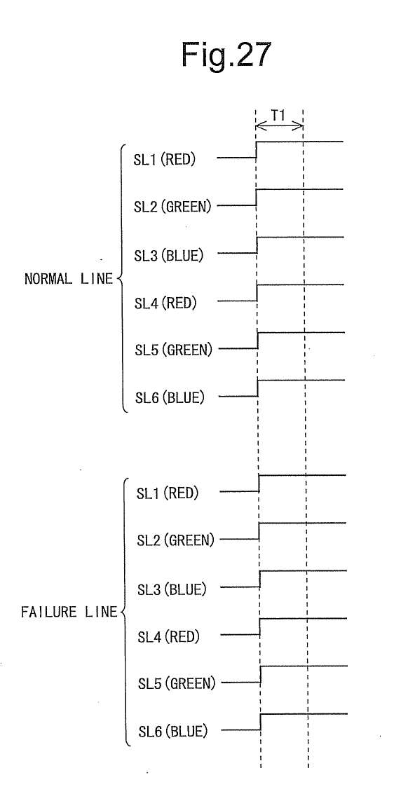

FIG. 27 is a signal waveform diagram showing a change of potentials of the source bus lines SL1 to SL6 when an R/G write test is performed. In this case, in the first period T1, out of the distribution control signals, ASW2, ASW3, ASW5, and ASW6 are set to a high level. When a close failure is not present in a sampling switch, an operation similar to that of the R/W write test described above is performed, and white display is performed.

When a close failure is present in a sampling switch, the following operation is performed. In this case, it is assumed that the sampling switch TRU1 has a close failure. In the first period T1, because T_ASW1, _T_ASW2, T_ASW4, and T_ASW5 become at a high level as for the inspection-use distribution control signals, the test switches TRT1, TGT1, TRT2, and TGT2 become in an on state. Accordingly, the test video signal T_VIDEO at a high level is applied to the source bus lines SL1, SL2, SL4, and SL5, via the test switches TRT1, TGT1, TRT2, and TGT2. In the first period T1, because U_ASW2, U_ASW3, U_ASW5, and U_ASW6 become at a high level as for the normal-use distribution control signals, the sampling switches TGU1, TBU1, TGU2, and TBU2 become in an on state. Accordingly, the test video signal T_VIDEO at a high level that is applied to the source bus lines SL2, SL5 are also applied to the source bus lines SL3, SL6 via sampling switches that are in an on state. In this way, at a time point when the first period T1 ends, the source bus lines SL1 to SL6 are in a state of being applied with a voltage of a high level. As a result, regarding this test, white display is performed, in spite of presence of a sampling switch that has a close failure.

### 2. 2. 2. 3 G/B Write Test

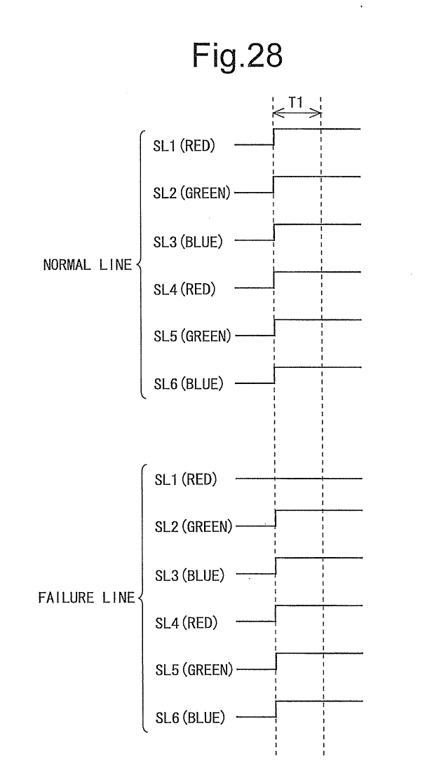

FIG. 28 is a signal waveform diagram showing a change of potentials of the source bus lines SL1 to SL6 when a G/B write test is performed. In this case, in the first period T1, out of the distribution control signals, ASW1, ASW3, ASW4, and ASW6 are set to a high level. When a close failure is not present in a sampling switch, an operation similar to that of the R/B write test described above is performed, and white display is performed.

When a close failure is present in a sampling switch, the following operation is performed. In this case, it is assumed that the sampling switch TRU1 has a close failure. In the first period T1, because T_ASW2, T_ASW3, T_ASW5, and T_ASW6 become at a high level as for the inspection-use distribution control signals, the test switches TGT1, TBT1, TGT2, and TBT2 become in an on state. Accordingly, the test video signal T_VIDEO at a high level is applied to the source bus lines SL2, SL3, SL5, and SL6, via the test switches TGT1, TBT1, TGT2, and TBT2. In the first period T1, although U_ASW1, U_ASW3, U_ASW4, and U_ASW6 become at a high level as for the normal-use distribution control signals, because it is assumed that the sampling switch TRU1 has a close failure, the sampling switches TBU1, TRU2, and TBU2 become in an on state. Accordingly, the test video signal T_VIDEO at a high level that is applied to the source bus lines SL3, SL6 is also applied to the source bus line SL4 via sampling switches that are in an on state. However, because the sampling switch TRU1 is in an off state, the test video signal T_VIDEO is not provided to the source bus line SL1. In this way, at a time point when the first period T1 ends, the source bus lines SL2 to SL6 are in a state of being applied with a voltage of a high level, and the source bus line SL1 is in a state of being applied with a voltage of an intermediate level. As a result, white display is not performed in a region of lines in which a sampling switch that has a close failure is present.

### 2. 2. 2. 4 Conclusion

As described above, also in the present embodiment, in a region of lines in which a sampling switch that has a close failure is present, white display is not performed in all of or in a part of an R/B write test, an R/G write test, and a G/B write test. Accordingly, a close failure of a sampling switch can be also detected in a configuration that a one-input and six-output demultiplexer is provided in the first distribution circuit 20.

### 2. 3. Effect

According to the present embodiment, regarding a liquid crystal panel having a configuration in which a one-input and six-output demultiplexer is provided in the first distribution circuit 20 and the second distribution circuit 30, it also becomes possible to detect a failure of a sampling switch that operates in a normal-period when performing a panel inspection, without increasing a circuit scale.

### 3. Third Embodiment

### 3. 1 Configuration

A configuration of a liquid crystal panel according to a third embodiment of the present invention is similar to the configuration in the first embodiment (see FIG. 1 to FIG. 5). In the first embodiment, the second distribution circuit 30 is used as a circuit for inspecting a panel (before a driver IC is mounted, as a representative case). However, in the present embodiment, it is used as a circuit for precharging source bus lines. Therefore, the second distribution circuit 30 can be also used as a circuit for inspecting a panel, and can be also used as a circuit for precharge. For the sake of description, the “test video signal” in the first embodiment is called a “precharge video signal”, and the “test switch” in the first embodiment is called a “precharge switch”.

### 3. 2 Driving Method

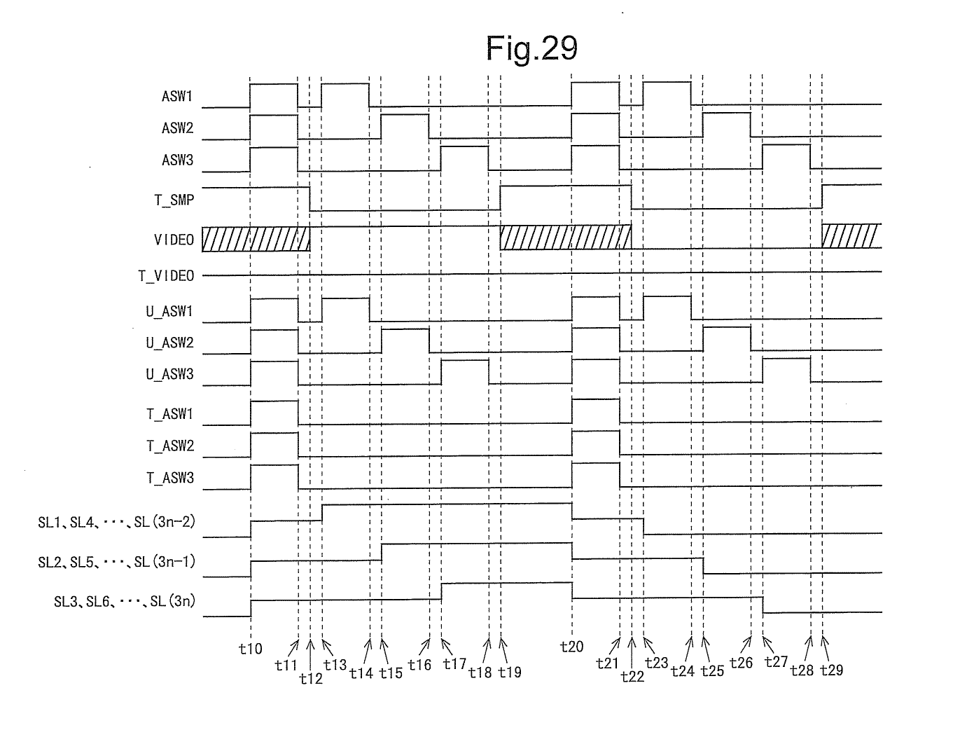

A driving method of a source bus line when the second distribution circuit 30 is used as a circuit for precharge is described next with reference to FIG. 29. In the present embodiment, there is employed what is called a line-reversal driving method that reverses positive and negative polarities of voltage applied to a liquid crystal layer every one gate bus line. Therefore, to each source bus line, a video signal of different polarity is applied to one horizontal scanning period. In FIG. 29, a certain horizontal scanning period is started at a time point t10, and a next horizontal scanning period is started at a time point t20. A precharge video signal T_VIDEO is fixed to a potential of an intermediate gradation. Although a video signal VIDEO that is applied to a source bus line is shown by one waveform in FIG. 29, a video signal of which a potential is different corresponding to an image to be displayed is actually applied to each source bus line.

At a time point t10, the control signals ASW1 to ASW3 are set to a high level. At this time, because the control signal T_SMP is at a high level, the switches SW1 to SW3 are in an on state. Therefore, at the time point t10, the control signals U_ASW1 to U_ASW3 and T ASW1 to T_ASW3 become at a high level. Accordingly, all sampling switches and all precharge switches become in an on state. At a time point to, the first distribution circuit 20 and the source driver 40 are in a state of being electrically disconnected, and a potential of the video signal VIDEO is indefinite. Based on the above, at the time point t10, a precharge potential (a potential of the precharge video signal T_VIDEO) is written to all source bus lines.

At a time point t11, the control signals ASW1 to ASW3 are set to a low level. Accordingly, all sampling switches and all precharge switches become in an off state. At a time point t12, the control signal T_SMP is set to a low level. Accordingly, the switches SW1 to SW3 become in an off state. At the time point t12, the first distribution circuit 20 and the source driver 40 are electrically connected to each other, and the video signal VIDEO corresponding to an image to be displayed is provided from the source driver 40 to the first distribution circuit 20.

At a time point t13, the control signal ASW1 is set to a high level. Accordingly, the control signal U_ASW1 becomes at a high level. At this time, because the control signal T_SMP is at a low level, the switch SW1 is in an off state. Therefore, the control signal T_ASW3 is maintained at a low level. Consequently, the sampling switches TRU1, TRU2, . . . , TRUn become in an on state. As a result, a video signal VIDEO corresponding to an image to be displayed is applied to the source bus lines SL1, SL4, . . . , SL(3n-2) for red. At a time point t14, the control signal ASW1 is set to a low level. Accordingly, the control signal U_ASW1 becomes at a low level, and the sampling switches TRU1, TRU2, . . . , TRUn become in an off state.

In a similar manner to that in a period from the time point t13 to the time point t14, a video signal VIDEO corresponding to an image to be displayed is applied to the source bus lines SL2, SL5, . . . , SL (3n-1) for green in a period from a time point t15 to a time point t16, and a video signal VIDEO corresponding to an image to be displayed is applied to the source bus lines SL3, SL6, . . . , SL (3n) for blue in a period from a time point t17 to a time point t18.

At a time point t19, the control signal T_SMP is set to a high level. Accordingly, the switches SW1 to SW3 are set to an on state. Also, the first distribution circuit 20 and the source driver 40 are set to a state of being electrically separated from each other, and a potential of the video signal VIDEO becomes indefinite.

In a period from a time point t20 to a time point t28, in a similar manner to that in the period from the time point t10 to the time point t18, after a precharge potential is written to all source bus lines, a video signal VIDEO corresponding to an image to be displayed is applied to source bus lines in an order of red, green, and blue. Note that, a polarity of a video signal VIDEO to be applied to a source bus line in a period from the time point t13 to the time point t18 and a polarity of a video signal VIDEO to be applied to a source bus line in a period from the time point t23 to the time point t28 are opposite to each other.

### 3. 3 Effect

According to the present embodiment, the first distribution circuit 20 that includes demultiplexers for outputting the video signal VIDEO to a plurality of source bus lines is provided at one end side of the source bus lines, and the second distribution circuit 30 that includes demultiplexers for outputting a predetermined input signal to the plurality of source bus lines is provided at the other end side of the source bus lines. In such a configuration, the precharge video signal T_VIDEO that is fixed to a potential of an intermediate gradation is applied to the second distribution circuit 30 as the predetermined input signal. Then, in an initial predetermined period of each horizontal scanning period, all switches that constitute demultiplexers in the second distribution circuit 30 are set to an on state. Accordingly, a precharge potential is written to all source bus lines. Thereafter, all switches that constitute demultiplexers in the second distribution circuit 30 are set to an off state, and the video signal VIDEO corresponding to an image to be displayed is applied from a first distribution circuit 20 side to each source bus line. In this way, a precharge is performed to source bus lines in each horizontal scanning period. Therefore, a reach time to a target applied voltage is shortened in each pixel formation portion, and display quality is improved.

In the present embodiment, circuit configurations (configurations of the first distribution circuit 20 and the second distribution circuit 30) are the same as those in the first embodiment. Therefore, by only providing a circuit having a relatively simple configuration, it is possible to obtain effect that a failure of a sampling switch that operates in a normal-period can be also detected when performing a panel inspection, and it is possible to obtain effect that a precharge to source bus lines becomes possible and display quality is improved.

### 3. 4 Modification

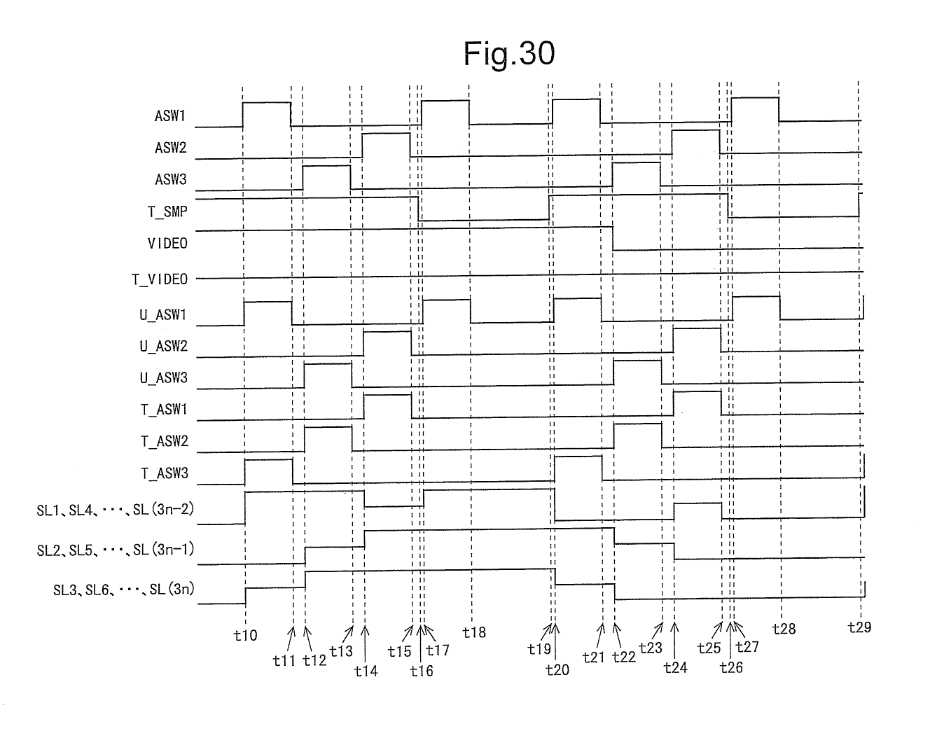

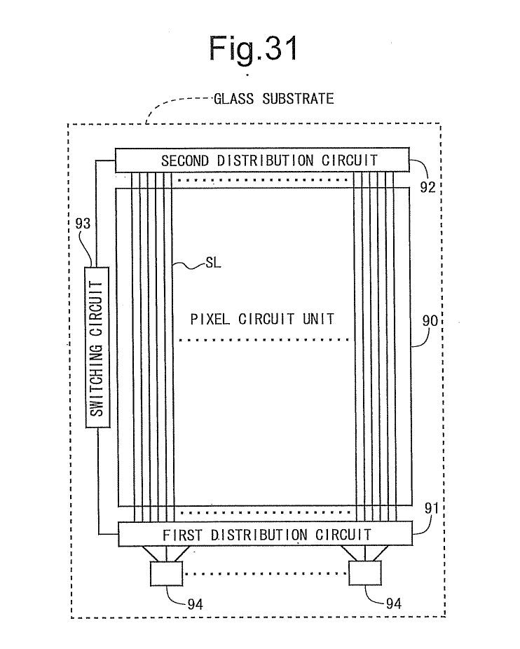

According to the third embodiment, after a precharge potential is written to all source bus lines, the video signal VIDEO corresponding to an image to be displayed is applied to source bus lines in an order of red, green, and blue, however, the present invention is not limited thereto. Writing of a precharge potential and writing of a video signal potential to source bus lines can be also performed in an order of blue, green, and red, as follows. A driving method of a source bus line in the present modification is described below with reference to FIG. 30. Also in the present modification, the precharge video signal T_VIDEO is fixed to a potential of an intermediate gradation.

At the time point t10, the control signal ASW1 is set to a high level. At this time, because the control signal T_SMP is at a high level, the switch SW1 is in an on state. Therefore, at the time point t10, the control signals U_ASW1, T_ASW3 become at a high level. Consequently, the sampling switches TRU1, TRU2, . . . , TRUn and the precharge switches TBT1, TBT2, . . . , TBTn become in an on state. As a result, at the time point t10, a potential of the video signal VIDEO is written to the source bus lines SL1, SL4, . . . , SL(3n-2) for red, and a precharge potential is written to the source bus lines SL3, SLG, . . . , SL(3n) for blue. Note that, a potential of the video signal VIDEO at the time point t10 is a temporary potential, and original writing to the source bus lines SL1, SL4, . . . , SL (3n-2) for red is performed at the time point t17, as described later. At the time point t11, the control signal ASW1 is set to a low level. Accordingly, the control signals U_ASW1, T_ASW3 become at a low level, and the sampling switches TRU1, TRU2, . . . , TRUn and the precharge switches TBT1, TBT2, . . . , TBTn become in an off state.

At the time point t12, the control signal ASW3 is set to a high level. Therefore, the control signals U_ASW3, T_ASW2 become at a high level. Accordingly, the sampling switches TBU1, TBU2, . . . , TBUn and the precharge switches TGT1, TGT2, . . . , TGTn become in an on state. Accordingly, at the time point t12, a potential of the video signal VIDEO is written to the source bus lines SL3, SL6, . . . , SL(3n) for blue, and a precharge potential is written to the source bus lines SL2, SL5, . . . , SL(3n-1) for green. At the time point t13, the control signal ASW3 is set to a low level. Accordingly, the control signals U_ASW3, T_ASW2 become at a low level, and the sampling switches TBU1, TBU2, . . . , TBUn and the precharge switches TGT1, TGT2, . . . , TGTn become in an off state.

At the time point t14, in a similar manner to that at the time point t12, a potential of the video signal VIDEO is written to the source bus lines SL2, SL5, . . . , SL(3n-1) for green, and a precharge potential is written to the source bus lines SL1, SL4, . . . , SL(3n-2) for red.

After the control signal ASW2 becomes at a low level at the time point t15, when reaching the time point t16, the control signal T_SMP is set to a low level. Accordingly, the switches SW1 to SW3 become in an off state, and all precharge switches become in an off state. At the time point t17, the control signal ASW1 is set to a high level. Accordingly, the control signal U_ASW1 becomes at a high level. At this time, because the switch SW1 is in an off state, the control signal T_ASW3 is maintained at a low level. Consequently, the sampling switches TRU1, TRU2, . . . , TRUn become in an on state. As a result, a potential of the video signal VIDEO is written to the source bus lines SL1, SL4, . . . , SL(3n-2) for red. At the time point t18, the control signal ASW1 is set to a low level. Accordingly, the control signal U_ASW1 becomes at a low level, and the sampling switches TRU1, TRU2, . . . , TRUn become in an off state. At the time point t19, the control signal T_SMP is set to a high level. Accordingly, the switches SW1 to SW3 become in an on state.

In a period from the time point t20 to the time point t29, in a similar manner to that in the period from the time point t10 to the time point t19, writing of a precharge potential and writing of a video signal potential to source bus lines are performed in an order of blue, green, and red. Note that, a polarity of a video signal to be written to a source bus line in a period from the time point t12 to the time point t18 and a polarity of a video signal to be written to a source bus line in a period from the time point t22 to the time point t28 become opposite to each other.

As described above, also in the present modification, by only providing a circuit having a relatively simple configuration, it is possible to obtain effect that a failure of a sampling switch that operates in a normal-period can be also detected when performing a panel inspection, and it is possible to obtain effect that a precharge to source bus lines are possible and display quality is improved.

### 4. Others

Although the description has been made by taking an example of a liquid crystal panel in each of the above embodiments, the present invention is not limited thereto. The present invention can be also applied to a display panel other than a liquid crystal panel, such as an organic EL (Electro Luminescence) panel.

### DESCRIPTION OF REFERENCE CHARACTERS

10 . . . Pixel circuit unit
20 . . . First distribution circuit
30 . . . Second distribution circuit
31, 35 . . . Distribution unit
32, 33, 34, 36 . . . Operation control unit
40 . . . Source driver (video signal line drive circuit)
DMU1 to DMUn, DMT1 to DMTn Demultiplexer
SL1 to SL(3n) . . . Source bus line
TRT1 to TRTn, TGT1 to TGTn, TBT1 to TBTn . . . Test switch
TRU1 to TRUn, TGU1 to TGUn, TBU1 to TBUn . . . Sampling switch
ASW1 to ASW6 . . . Distribution control signal
U_ASW1 to U_ASW6 Normal-use distribution control signal
T_ASW1 to T_ASW6 Inspection-use distribution control signal
T_SMP . . . Switching control signal
T_VIDEO . . . Test video signal

1. A display panel comprising:
a display unit in which a plurality of video signal lines are disposed that constitute a set of grouped video signal lines for every n (n is a natural number equal to or larger than two) video signal lines;
a first demultiplexer provided for each of the set of grouped video signal lines at one end side of the plurality of video signal lines and including n first switches adapted to switch whether to apply a first video signal transmitted from an outside to each of the n video signal lines included in the grouped video signal lines;
a second demultiplexer provided for each of the set of grouped video signal lines at the other end side of the plurality of video signal lines and including n second switches adapted to switch whether to apply a second video signal transmitted from an outside to each of the n video signal lines included in the grouped video signal lines; and
an operation control unit adapted to switch whether to allow the second video signal to be applied to the plurality of video signal lines, wherein
states of the n first switches included in the first demultiplexer are controlled by n control signals which are different from each other,
states of the n second switches included in the second demultiplexer are controlled by the n control signals which are different from each other, and
when an any control signal out of the n control signals is defined as a target control signal, for each grouped video signal line, a video signal line connected to a first switch which is set to an on state by the target control signal and a video signal line connected to a second switch which is set to an on state by the target control signal are different.

2. The display panel according to claim 1, wherein
the operation control unit includes n control switches provided respectively corresponding to the n second switches included in the second demultiplexer, and
each of the control switches controls whether to provide the control signal to the second switch, based on a switching control signal provided from an outside.

3. The display panel according to claim 1, wherein
the operation control unit includes a plurality of control switches which are provided respectively corresponding to the plurality of video signal lines and are provided between an output unit of the second demultiplexer and the display unit, and
each of the control switches switches whether to allow the second video signal to be applied from the output unit of the second demultiplexer to the plurality of video signal lines, based on a switching control signal provided from an outside.

4. The display panel according to claim 1, wherein
the operation control unit includes a plurality of control switches which are provided respectively corresponding to the plurality of video signal lines and are provided near an input unit of the second demultiplexer, and
each of the control switches switches whether to apply the second video signal to the input unit of the second demultiplexer, based on a switching control signal provided from an outside.

5. The display panel according to claim 1, wherein
the second video signal is provided in common to input units of all second demultiplexers provided at the other end side of the plurality of video signal lines.

6. The display panel according to claim 1, wherein
the n first switches included in the first demultiplexer and the n second switches included in the second demultiplexer are thin-film transistors.

7. A display module comprising the display panel according to claim 1, wherein
a video signal line drive circuit that applies the first video signal to the first demultiplexer is mounted on the display panel.

8. An inspection method of a display panel that includes a display unit in which a plurality of video signal lines are disposed that constitute a set of grouped video signal lines for every n (n is a natural number equal to or larger than two) video signal lines, a first demultiplexer provided for each of the set of grouped video signal lines at one end side of the plurality of video signal lines and including n first switches adapted to switch whether to apply a first video signal transmitted from an outside to each of the n video signal lines included in the grouped video signal lines, a second demultiplexer provided for each of the set of grouped video signal lines at the other end side of the plurality of video signal lines and including n second switches adapted to switch whether to apply a second video signal transmitted from an outside to each of the n video signal lines included in the grouped video signal lines, an operation control unit adapted to switch whether to allow the second video signal to be applied to the plurality of video signal lines, and a control signal input unit for receiving n control signals transmitted from an outside, the inspection method comprising:
an inspection preparation step of enabling the operation control unit to apply the second video signal to the plurality of video signal lines;
a first level application step of changing a signal level of one of the n control signals such that one of the n first switches included in the first demultiplexer provided corresponding to each grouped video signal line and one of the n second switches included in the second demultiplexer provided corresponding to each grouped video signal line are maintained in an on state in a predetermined period, when a signal level of the second video signal is at a predetermined first level; and
a second level application step of changing a signal level of one of the n control signals such that one of the n first switches included in the first demultiplexer provided corresponding to each grouped video signal line and one of the n second switches included in the second demultiplexer provided corresponding to each grouped video signal line are maintained in an on state in a predetermined period, when a signal level of the second video signal is at a second level which is different from the first level, wherein
when an any control signal out of the n control signals is defined as a target control signal, for each grouped video signal line, a video signal line connected to a first switch which is set to an on state by the target control signal and a video signal line connected to a second switch which is set to an on state by the target control signal are different,
the first level application step is performed such that the second video signal of the first level is applied to a video signal line which corresponds to a display color to be tested, and
the second level application step is performed such that the second video signal of the second level is applied to a video signal line which corresponds to a display color not to be tested.

9. An inspection method of a display panel that includes a display unit in which a plurality of video signal lines are disposed that constitute a set of grouped video signal lines for every n (n is a natural number equal to or larger than two) video signal lines, a first demultiplexer provided for each of the set of grouped video signal lines at one end side of the plurality of video signal lines and including n first switches adapted to switch whether to apply a first video signal transmitted from an outside to each of the n video signal lines included in the grouped video signal lines, a second demultiplexer provided for each of the set of grouped video signal lines at the other end side of the plurality of video signal lines and including n second switches adapted to switch whether to apply a second video signal transmitted from an outside to each of the n video signal lines included in the grouped video signal lines, an operation control unit adapted to switch whether to allow the second video signal to be applied to the plurality of video signal lines, and a control signal input unit for receiving n control signals transmitted from an outside, the inspection method comprising:
an inspection preparation step of enabling the operation control unit to apply the second video signal to the plurality of video signal lines; and
an m-line write step of changing levels of m signals out of the n control signals such that m (m is a natural number smaller than n) switches out of the n first switches included in the first demultiplexer provided corresponding to each grouped video signal line and m switches out of the n second switches included in the second demultiplexer provided corresponding to each grouped video signal line are maintained in an on state in a predetermined period, when a signal level of the second video signal is at a predetermined first level, wherein
when an any control signal out of the n control signals is defined as a target control signal, for each grouped video signal line, a video signal line connected to a first switch which is set to an on state by the target control signal and a video signal line connected to a second switch which is set to an on state by the target control signal are different.
